(19) United States
(12) Patent Application Publication
(10) Pub. No.: US 2023/0098426 A1
(43) Pub. Date: Mar. 30, 2023

(54) TONER

(71) Applicant: CANON KABUSHIKI KAISHA, Tokyo (JP)

(72) Inventors: Takashi Matsui, Shizuoka (JP); Daisuke Yoshiba, Shizuoka (JP); Yuna Yamamoto, Tokyo (JP)

(21) Appl. No.: 17/931,706

(22) Filed: Sep. 13, 2022

(30) Foreign Application Priority Data
Sep. 16, 2021 (JP) 2021-150940
Jul. 20, 2022 (JP) 2022-115658
Aug. 24, 2022 (JP) 2022-132888

(51) Int. Cl. G03G 9/087; G03G 9/08; G03G 9/093; G03G 9/09; C08F 220/18; C08F 220/06; C08F 220/44; C08F 220/58; C08F 212/08

(52) U.S. Cl. CPC G03G 9/08711; G03G 9/08795; G03G 9/0806; G03G 9/09364; G03G 9/09321; G03G 9/0904; C08F 220/1812; C08F 220/1818; C08F 220/06; C08F 220/44; C08F 220/585; C08F 212/08

(57) ABSTRACT

The toner is characterized in that, wherein the binder resin is a resin satisfying at least one of the following specification (A) or (B): (A) the binder resin contains a crystalline resin having a unit (a) represented by the following formula (1) and a resin having a sulfide structure; and (B) the binder resin contains a crystalline resin having the sulfide structure and having the unit (a) represented by the following formula (1):

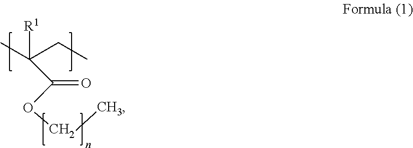

wherein the colorant is any colorant selected from the specific group consisting of: carbon black and so on, wherein when the toner is subjected to measurement with a differential scanning calorimeter, a peak temperature of a maximum endothermic peak is present in a range of from 50° C. or more to 70° C. or less, and wherein the maximum endothermic peak has an endothermic quantity of 30 J/g or more and 70 J/g or less.

### BACKGROUND

### Field of the Disclosure

The present disclosure relates to a toner to be used in an electrophotographic method or an electrostatic recording method.

### Description of the Related Art

In recent years, energy savings in an electrophotographic apparatus have been considered to be a large technical problem, and hence a significant reduction in quantity of heat to be applied to a fixing device has been investigated. In particular, in a toner, there has been a growing need for so-called “low-temperature fixability” by which the toner can be fixed with lower energy.

An approach to enabling the fixation of the toner at low temperatures is, for example, to reduce the glass transition point (Tg) of a binder resin in the toner. However, the reduction in Tg leads to a reduction in heat-resistant storage stability of the toner, and hence it has been considered to be difficult to achieve both of the low-temperature fixability and heat-resistant storage stability of the toner in the approach.

In view of the foregoing, a method including using a crystalline vinyl resin as the binder resin has been investigated for achieving both of the low-temperature fixability and heat-resistant storage stability of the toner. Although an amorphous resin to be generally used as a binder resin for a toner shows no clear endothermic peak in differential scanning calorimeter (DSC) measurement, an endothermic peak in the DSC measurement appears when the toner contains a crystalline resin component. The crystalline vinyl resin has the following property: side chains in a molecule thereof are regularly arrayed, and hence the resin hardly softens until its melting point. In addition, the crystal of the resin abruptly melts at the melting point as a boundary, and an abrupt reduction in viscosity thereof occurs along with the melting. Accordingly, the resin has been attracting attention as a material that is excellent in sharp melt property, and achieves both of low-temperature fixability and heat-resistant storage stability. Typically, the crystalline vinyl resin has long-chain alkyl groups as side chains in its main chain skeleton, and the long-chain alkyl groups serving as the side chains crystallize to enable the resin to show crystallinity.

Meanwhile, from the viewpoint of improving the quality of a color image, a toner having high coloring power has been required. To cope with the requirement, various investigations have been made on a binder resin and a colorant to be incorporated into the toner.

In Japanese Patent Application Laid-Open No. 2019-219648, there has been provided a positively chargeable toner excellent in low-temperature fixability and heat-resistant storage stability, and durability and chargeability.

In addition, in Japanese Patent Application Laid-Open No. 2017-037245, there has been provided a toner for developing an electrostatic charge image, which has satisfactory low-temperature fixability and is hardly reduced in fixability even after its storage in a high-temperature state.

The positively chargeable toner described in Japanese Patent Application Laid-Open No. 2019-219648 has shown improvements in low-temperature fixability and heat-resistant storage stability indeed, but has still been susceptible to improvement in terms of achievement of both of these properties and high coloring power. In addition, the toner for developing an electrostatic charge image described in Japanese Patent Application Laid-Open No. 2017-037245 has also still been susceptible to improvement in terms of achievement of both of low-temperature fixability and high coloring power.

### SUMMARY

In view of the foregoing, an object of the present disclosure is to provide a toner that achieves all of low-temperature fixability, heat-resistant storage stability, and high coloring power.

The present disclosure for solving the above-mentioned problems relates to a toner including toner particles each containing a binder resin and a colorant, wherein the binder resin is a resin satisfying at least one of the following specification (A) or (B): (A) the binder resin contains a crystalline resin having a unit (a) represented by the following formula (1) and a resin having a sulfide structure; and (B) the binder resin contains a crystalline resin having the sulfide structure and having the unit (a) represented by the following formula (1):

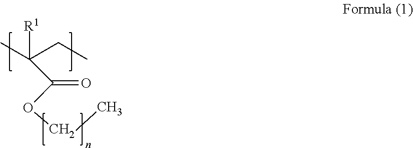

in the formula (1), R¹ represents a hydrogen atom or a methyl group, and “n” represents an integer of 16 or more and 30 or less, wherein the colorant is any colorant selected from the group consisting of: carbon black; titanium black; copper phthalocyanine; a copper phthalocyanine derivative; an anthraquinone compound; an azo pigment; and a fused polycyclic compound, wherein when the toner is subjected to measurement with a differential scanning calorimeter, a peak temperature of a maximum endothermic peak is present in a range of from 50° C. or more to 70° C. or less, and wherein the maximum endothermic peak has an endothermic quantity of 30 J/g or more and 70 J/g or less.

According to the present disclosure, it is possible to provide the toner that achieves all of low-temperature fixability, heat-resistant storage stability, and high coloring power.

Further features of the present disclosure will become apparent from the following description of exemplary embodiments.

### DESCRIPTION OF THE EMBODIMENTS

The description “∘∘ or more and xx or less” or “from ∘∘ to xx” representing a numerical range means a numerical range including a lower limit and an upper limit that are end points unless otherwise stated.

The expression “(meth)acrylic acid ester” includes both of an acrylic acid ester and a methacrylic acid ester, and the expression “(meth)acrylic acid” includes both of acrylic acid and methacrylic acid.

When numerical ranges are described in stages, the upper limits and lower limits of the numerical ranges may be combined in any combination.

A monomer unit is a unit for forming a polymer (a polymer or a resin), and refers to a form obtained by a reaction between monomer (polymerizable monomer) molecules. For example, one interval of a carbon-carbon bond in a main chain obtained by the polymerization of a vinyl-based monomer in a polymer is one monomer unit. The vinyl-based monomer may be represented by the following formula (Z), and a vinyl-based monomer unit is a constituent unit for the polymer and is a form obtained by a reaction between the molecules of the monomer represented by the following formula (Z). In addition, the monomer unit is sometimes simply represented as “unit”.

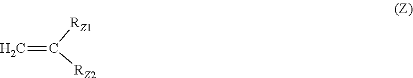

A crystalline resin refers to a resin showing a clear endothermic peak in differential scanning calorimeter (DSC) measurement in which the resin and toner particles or a toner are used as measurement samples.

The achievement of both of low-temperature fixability and heat-resistant storage stability requires the entirety of a binder resin to have crystallinity. To that end, long-chain alkyl groups present as side chains in the main chain skeleton of the binder resin need to sufficiently crystallize. Accordingly, the content of the long-chain alkyl groups needs to be high, and a melting point expressed by the resin needs to fall within a range enough to secure the heat-resistant storage stability.

Meanwhile, in order for the toner to have a high coloring property, a colorant such as a pigment needs to be uniformly dispersed in each of the toner particles.

Carbon black, titanium black, copper phthalocyanine, a copper phthalocyanine derivative, an anthraquinone compound, an azo pigment, and a fused polycyclic compound that are colorants each generally have a polar group. In contrast, a crystalline resin having a unit (a) is liable to be a configuration having low polarity. Accordingly, there has been a problem in that an affinity between the crystalline resin having the unit (a) and each of the colorants tends to be low, and hence the dispersibility of the colorant reduces to reduce the coloring power of the toner.

In view of the foregoing, the inventors of the present disclosure have made extensive investigations, and as a result, have found that when a resin having a sulfide structure is caused to be present in the binder resin, the dispersibility of the colorant in each of the toner particles can be improved by the influence of high polarity based on a sulfur atom in the sulfide structure, and hence the coloring power can be improved. Thus, the inventors have reached the present disclosure.

A toner of the present disclosure is described in detail below.

A binder resin to be incorporated into each of toner particles according to the present disclosure is a resin satisfying at least one of the following specification (A) or (B):

(A) the binder resin contains a crystalline resin having a unit (a) represented by the formula (1) and a resin having a sulfide structure; and

(B) the binder resin contains a crystalline resin having the sulfide structure and having the unit (a) represented by the formula (1).

When the unit (a) has a long-chain alkyl group (alkyl group in which the number (n) of carbon atoms is 16 or more and 30 or less) as a side chain in the binder resin, the binder resin has crystallinity, and hence a toner having excellent low-temperature fixability and excellent heat-resistant storage stability is obtained. In addition, the binder resin becomes a crystalline resin showing a clear endothermic peak in DSC measurement.

The unit (a) can be incorporated into the binder resin by subjecting a (meth)acrylic acid ester having a linear alkyl group having 16 or more and 30 or less carbon atoms as a polymerizable monomer to vinyl polymerization.

Examples of the (meth)acrylic acid ester having an alkyl group having 16 or more and 30 or less carbon atoms include cetyl (meth)acrylate, stearyl (meth)acrylate, nonadecyl (meth)acrylate, eicosyl (meth)acrylate, heneicosyl (meth)acrylate, behenyl (meth)acrylate, lignoceryl (meth)acrylate, hexacosyl (meth)acrylate, octacosyl (meth)acrylate, and myricyl (meth)acrylate.

Of those, a (meth)acrylic acid ester having an alkyl group having 18 or more and 30 or less carbon atoms is more preferred, and stearyl (meth)acrylate or behenyl (meth)acrylate is more preferred from the viewpoints of the low-temperature fixability and heat-resistant storage stability of the toner.

That is, in the formula (1), the number (n) of the carbon atoms is preferably 16 or more and 30 or less, more preferably 18 or more and 30 or less, still more preferably 18 or more and 22 or less. In addition, R¹ preferably represents hydrogen.

The polymerizable monomers for forming the unit (a) (hereinafter also represented as “monomers (a)”) and the units (a) may be used alone or in combination thereof.

The content of the unit (a) in the crystalline resin is preferably 40.0 mass % or more and 80.0 mass % or less.

When the content is 40.0 mass % or more, a toner that is improved in crystallinity, and has excellent low-temperature fixability and excellent heat-resistant storage stability is obtained. The content is more preferably 45.0 mass % or more.

When the content is 80.0 mass % or less, it becomes easier to improve pigment dispersibility, and hence a toner having higher coloring power is obtained. The content is more preferably 75.0 mass % or less, still more preferably 60.0 mass % or less.

In addition, the content of the unit (a) is the sum of the contents of all the units each represented by the formula (1).

Next, the specifications (A) and (B) satisfied by the above-mentioned binder resin are described.

First, as described above, the “crystalline resin having a unit (a)” in the specification (A) can be incorporated into the binder resin by subjecting the (meth)acrylic acid ester having an alkyl group having 16 or more and 30 or less carbon atoms to vinyl polymerization with any other polymerizable monomer.

Meanwhile, the “resin having a sulfide structure” in the specification (A) may be obtained by, for example: adding mercaptans, such as t-dodecylmercaptan, n-dodecylmercaptan, n-octylmercaptan, and 2,2,4,6,6-pentamethylheptane-4-thiol, or thiuram disulfides, such as tetramethylthiuram disulfide, tetraethylthiuram disulfide, tetrabutylthiuram disulfide, N,N′-dimethyl-N,N′-diphenylthiuram disulfide, and N,N′-dioctadecyl-N,N′-diisopropylthiuram disulfide, to a polymerizable monomer; and subjecting the mixture to vinyl polymerization.

The term “sulfide structure” refers to a structure represented by R—S—R in which organic groups R are bonded to both the sides of a sulfur atom. In addition, the term “resin having a sulfide structure” in the present disclosure refers to the following product: the product has the structure represented by R—S—R, and at least one of the organic groups R bonded to the sulfur atom is a polymer, and hence the product can be regarded as a resin as a whole.

The presence of the sulfide structure is required in the present disclosure from the viewpoint that the resin having the sulfide structure is uniformly dispersed in the binder resin with ease, and hence can interact with the colorant in terms of polarity. Similarly, when a sulfonic acid group is introduced as a functional group containing a sulfur element instead of the sulfide structure, the resin having introduced thereinto the group has polarity, but the colorant tends to be liable to aggregate probably because the polarity is excessively high, with the result that the coloring power of the toner reduces.

The mercaptans and/or the thiuram disulfides that are additives may be added before the initiation of the polymerization or during the polymerization. The addition amount of the mercaptans and/or the thiuram disulfides is preferably 0.01 part by mass or more and 10 parts by mass or less, more preferably 0.1 part by mass or more and 5 parts by mass or less with respect to 100 parts by mass of the polymerizable monomer.

Next, the “crystalline resin having the sulfide structure and having the unit (a) represented by the formula (1)” in the specification (B) may be obtained by: adding the (meth)acrylic acid ester having an alkyl group having 16 or more and 30 or less carbon atoms, the ester serving as a polymerizable monomer, and the above-mentioned mercaptans and/or thiuram disulfides that are additives; and subjecting the mixture to vinyl polymerization.

All of the low-temperature fixability, heat-resistant storage stability, and coloring power of the toner can be achieved when the binder resin

(A) contains the crystalline resin having the unit (a) represented by the formula (1) and the resin having the sulfide structure, or

(B) contains the crystalline resin having the sulfide structure and having the unit (a) represented by the formula (1).

In addition, the specification (B) out of the specifications (A) and (B) is preferably satisfied from the viewpoint that the coloring power can be satisfactorily improved. The inventors have conceived that this is because of the following reason: when the binder resin has the crystalline resin having the sulfide structure and having the unit (a), it becomes easier to improve the polarity of the entirety of the crystalline resin, and hence the resin can interact with a polar group in the colorant at a high frequency; and accordingly, the dispersibility of the colorant is improved to provide high coloring power.

When the binder resin satisfies the specification (A), the content of the crystalline resin having the unit (a) in the binder resin is preferably 50.0 mass % or more. When the content of the crystalline resin having the unit (a) becomes 50.0 mass % or more, it becomes easier to improve the low-temperature fixability and the heat-resistant storage stability.

In addition, in the case where the binder resin satisfies the specification (B), the content of the crystalline resin having the unit (a) and the sulfide structure in the binder resin is preferably 50.0 mass % or more. In this case as well, when the content of the crystalline resin having the unit (a) and the sulfide structure becomes 50.0 mass % or more, it becomes easier to improve the low-temperature fixability and the heat-resistant storage stability.

The colorant of the present disclosure is selected from carbon black, titanium black, copper phthalocyanine, a copper phthalocyanine derivative, an anthraquinone compound, an azo pigment, and a fused polycyclic compound.

The inventors have assumed that a hydroxy group, an alkoxy group, a carboxyl group, an aldehyde group, a ketone group, an imino group, an amino group, an azo group, or the like in each of those colorants interacts with the polar moiety of the sulfide structure to enable uniform dispersion of the colorant in the binder resin, and hence the coloring power of the present disclosure can be obtained.

When any one of the above-mentioned colorants is selected, the colorant interacts with the binder resin satisfying the specification (A) and/or the specification (B) to improve the coloring power.

Specific examples of the copper phthalocyanine compound, the derivative thereof, and the anthraquinone compound include C.I. Pigment Blue 2, 3, 6, 15, 15:1, 15:2, 15:3, 15:4, 16, 17:1, and 60.

Examples of the azo-based pigment and the fused polycyclic compound include C.I. Pigment Yellow 3, 12, 13, 14, 15, 17, 62, 65, 73, 74, 83, 93, 97, 120, 138, 155, 180, 181, 185, 186, and 213.

Further examples of the colorant include C.I. Pigment Red 31, 48, 57:1, 58, 60, 63, 64, 68, 81, 83, 87, 88, 89, 90, 112, 114, 122, 123, 144, 146, 149, 150, 163, 170, 184, 185, 187, 202, 206, 207, 209, 237, 238, 251, 254, 255, and 269, and C.I. Pigment Violet 19.

The colorant is preferably: carbon black; C.I. Pigment Red 31, 122, or 150; C.I. Pigment Yellow 74 or 155; or C.I. Pigment Blue 15 or 15:3.

Meanwhile, when the toner is subjected to measurement with a differential scanning calorimeter (DSC), the peak temperature of the maximum endothermic peak is preferably present in the range of from 50° C. or more to 70° C. or less. The fact that the toner has an endothermic peak means that the toner includes a component having crystallinity. When the maximum endothermic peak temperature is 50° C. or more, a toner having excellent storage stability and excellent durability is obtained, and when the temperature is 70° C. or less, a toner having excellent low-temperature fixability and excellent coloring power is obtained.

Accordingly, when the peak temperature of the maximum endothermic peak is present in the above-mentioned range, all of the low-temperature fixability, heat-resistant storage stability, and coloring power of the toner can be achieved. The peak temperature is more preferably 55° C. or more and 70° C. or less.

In addition, an endothermic quantity at the maximum endothermic peak of the toner of the present disclosure is 30 J/g or more and 70 J/g or less. The endothermic quantity represents the amount of a crystal component in the toner. When the endothermic quantity is 30 J/g or more, a toner that includes a large amount of the crystal component, and is excellent in low-temperature fixability and heat-resistant storage stability is obtained. In addition, when the endothermic quantity is 70 J/g or less, a toner that is improved in pigment dispersibility and is hence excellent in coloring power is obtained.

The endothermic quantity at the maximum endothermic peak is preferably 40 J/g or more and 60 J/g or less.

The binder resin preferably contains a monomer unit derived from a macromonomer. The term “macromonomer” means a polymer having a polymerizable functional group (e.g., an unsaturated group such as a carbon-carbon double bond) at a terminal thereof.

The macromonomer preferably has an acryloyl group or a methacryloyl group at a molecular chain terminal thereof. Of those, a methacryloyl group is more preferred because of the case with which the macromonomer is copolymerized.

The number-average molecular weight (Mn) of the monomer unit derived from the macromonomer is preferably 1,000 or more and 20,000 or less.

Polymerizable monomers for producing the unit (a) and a unit (b) to be described later do not belong to the definition of the above-mentioned macromonomer, and are polymerizable monomers each having a number-average molecular weight of less than 1,000.

In addition, the content of the monomer unit derived from the macromonomer in the binder resin is preferably 0.01 mass % or more and 5.00 mass % or less, more preferably 0.10 mass % or more and 1.00 mass % or less with respect to the binder resin.

When the content of the monomer unit derived from the macromonomer falls within the above-mentioned ranges, an effect to be described later is sufficiently obtained, and disproportionation at the time of the polymerization of the unit is easily suppressed.

When the binder resin has the monomer unit derived from the macromonomer, the branching of a long linear molecular chain occurs in its molecular chain. In addition, the self-aggregation of the long linear molecular chain enables the resin to easily have a microphase-separated structure. As a result, the alignment of the unit (a) is facilitated, and hence the holding of the crystalline moiety of the resin is facilitated. Accordingly, it becomes easier to improve the heat-resistant storage stability and durability of the toner.

In particular, when the number-average molecular weight of the monomer unit derived from the macromonomer is 1,000 or more and 20,000 or less, the branched structure moiety (also referred to as “graft structure moiety”) of the molecular chain easily moves, and hence the binder resin easily has the microphase-separated structure.

In addition, examples of a component for forming the long linear molecular chain (polymer moiety) include styrene, a styrene derivative, a methacrylic acid ester, an acrylic acid ester, acrylonitrile, and methacrylonitrile. Examples of the polymer moiety may include: a polymer obtained by polymerizing those components alone or in combination thereof; and a polymer having a polysiloxane skeleton.

The macromonomer is preferably at least one selected from the group consisting of (meth)acrylic acid ester polymers each having an acryloyl group or a methacryloyl group at a molecular chain terminal thereof. In this case, the (meth)acrylic acid ester polymer is present as a branched molecular chain in the monomer unit derived from the macromonomer. Accordingly, the aggregability of the monomer unit is further improved, and hence the holding of the crystalline moiety is further facilitated.

The crystalline resin preferably has a unit (b) satisfying the following specification in addition to the unit (a):

when the SP value of the unit (a) is represented by SPa and the SP value of the unit (b) is represented by SPb, the following formula (2) is satisfied.

3.0≤(SPb−SPa)≤25.0 (2)

When the formula (2) is satisfied, the crystallinity of the crystalline resin hardly reduces, and hence the melting point thereof is easily maintained. Thus, it becomes easier to achieve both of the low-temperature fixability and heat-resistant storage stability of the toner. Further, it becomes easier to improve the durability thereof. The inventors of the present disclosure have assumed a mechanism for the foregoing to be as described below.

The unit (a) is incorporated into the crystalline resin, and the alkyl groups of the unit (a) serving as side chains of the crystalline resin gather to form a domain. Thus, the crystallinity is expressed. In typical cases, when any other unit is incorporated, the crystallization of the unit (a) is liable to be inhibited, and hence the crystallinity is liable to reduce. Meanwhile, in the present disclosure, when the difference SPb−SPa falls within the range of the formula (2), the unit (a) and the unit (b) act so as to eliminate each other at the time of the crystallization. Accordingly, the crystallization of each of the units satisfactorily occurs, and hence high crystallinity is maintained.

Accordingly, it becomes easier to achieve both of the low-temperature fixability and the heat-resistant storage stability. Further, it becomes easier to improve the durability.

When the unit (a) contains two or more kinds of (meth)acrylic acid esters each having an alkyl group having 16 or more and 30 or less carbon atoms, the SPa represents a value calculated in accordance with the molar ratios of the respective units.

Meanwhile, when the unit (b) is formed of two or more kinds of polymerizable monomers, the SPb represents the SP value of a unit derived from each of the polymerizable monomers, and the difference SPb−SPa is determined for the unit derived from each of the polymerizable monomers.

The content of the unit (b) satisfying the formula (2) in the crystalline resin is preferably 20.0 mass % or more. When the content of the unit (b) is 20.0 mass % or more, the sharp melt property of the crystalline resin is easily exhibited, and hence the low-temperature fixability is further improved. In addition, the crystallinity of the resin hardly reduces, and hence the melting point thereof is easily maintained. Accordingly, the heat-resistant storage stability and the durability are further improved. When the two or more kinds of units (b) each satisfying the formula (2) are present in the crystalline resin, the ratio of the units (b) is defined as the total mass percentage of the units.

A polymerizable monomer (b) for forming the unit (b) is, for example, a polymerizable monomer satisfying the formula (2) out of polymerizable monomers given below.

The monomers (b) may be used alone or in combination thereof.

A monomer having a nitrile group, for example, acrylonitrile or methacrylonitrile.

A monomer having a hydroxy group, for example, 2-hydroxyethyl (meth)acrylate or 2-hydroxypropyl (meth)acrylate.

A monomer having an amide group, for example, acrylamide, or a monomer obtained by causing an amine having 1 or more and 30 or less carbon atoms and a carboxylic acid having an ethylenically unsaturated bond and having 2 or more and 30 or less carbon atoms (e.g., acrylic acid or methacrylic acid) to react with each other according to a known method.

A monomer having a urethane group, for example, a monomer obtained by causing an alcohol having an ethylenically unsaturated bond and having 2 or more and 22 or less carbon atoms (e.g., 2-hydroxyethyl methacrylate or vinyl alcohol) and an isocyanate having 1 or more and 30 or less carbon atoms to react with each other according to a known method, and a monomer obtained by causing an alcohol having 1 or more and 26 or less carbon atoms and an isocyanate having an ethylenically unsaturated bond and having 2 or more and 30 or less carbon atoms to react with each other according to a known method,

A monomer having a urea group, for example, a monomer obtained by causing an amine having 3 or more and 22 or less carbon atoms [e.g., a primary amine (e.g., n-butylamine, t-butylamine, propylamine, or isopropylamine), a secondary amine (e.g., di-n-ethylamine, di-n-propylamine, or di-n-butylamine), aniline, or cyclohexylamine] and an isocyanate having an ethylenically unsaturated bond and having 2 or more and 30 or less carbon atoms to react with each other according to a known method.

A monomer having a carboxy group, for example, methacrylic acid, acrylic acid, or 2-carboxyethyl (meth)acrylate.

In addition, vinyl esters, such as vinyl acetate, vinyl propionate, vinyl butyrate, vinyl caproate, vinyl caprylate, vinyl caprate, vinyl laurate, vinyl myristate, vinyl palmitate, vinyl stearate, vinyl pivalate, and vinyl octoate, are each used as the monomer (b).

Of those, a unit represented by the following formula (3) is preferred:

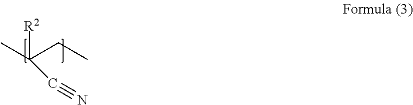

in the formula (3), R² represents a hydrogen atom or a methyl group.

The incorporation of the unit represented by the formula (3) suppresses the inhibition of the crystallization of the crystalline resin, and facilitates an increase in melting point thereof, and hence the low-temperature fixability and heat-resistant storage stability of the toner are improved. In addition, the unit has a highly polar nitrile group, and hence easily interacts with the colorant of the present disclosure. Accordingly, the dispersibility of the colorant is improved to easily improve the coloring power of the toner.

The unit represented by the formula (3) is preferably obtained by using methacrylonitrile. The use of methacrylonitrile makes it easier to improve the above-mentioned low-temperature fixability, heat-resistant storage stability, and coloring power, and facilitates more satisfactory suppression of fogging. This is probably because an electron-donating methyl group approaches the nitrile group, and hence the charge retentivity of the toner is improved to suppress charge leakage in an electrophotographic process.

The crystalline resin may contain one or more kinds of other units in addition to the unit (a) and the unit (b). For example, a unit derived from each of such polymerizable monomers as described below is preferred.

(Meth)acrylic acid esters, such as methyl (meth)acrylate, ethyl (meth)acrylate, n-butyl (meth)acrylate, t-butyl (meth)acrylate, and 2-ethylhexyl (meth)acrylate; and styrenes, such as styrene and α-methylstyrene.

Of those, ethyl methacrylate, n-butyl methacrylate, t-butyl methacrylate, or styrene is preferably used because the elasticity of the toner is appropriately controlled with ease.

The acid value of the crystalline resin is preferably 5.0 mgKOH/g or less. When a unit that may impart an acid value to the crystalline resin is present, the crystallization of the unit (a) is liable to be inhibited. Accordingly, when the acid value is 5.0 mgKOH/g or less, the crystallinity of the crystalline resin can be secured, and hence the low-temperature fixability and the heat-resistant storage stability are further improved with ease. The acid value is more preferably 3.0 mgKOH/g or less, still more preferably 0 mgKOH/g.

It is preferred that the toner particles each have a core-shell structure in which a core has the binder resin and a shell is an amorphous resin. When the core has the binder resin, it becomes easier to disperse the polar moiety of the sulfide structure, which is a feature of the present disclosure, in the entirety of the toner particles. Accordingly, the dispersibility of the colorant in each of the toner particles is improved to easily improve the coloring power of the toner. In addition, the shell is preferably the amorphous resin because it becomes easier to improve the chargeability and durability thereof.

The amorphous resin for forming the shell (hereinafter also referred to as “resin S”) preferably has 1.0 mass % or more and 30.0 mass % or less of a unit (c) represented by the formula (4):

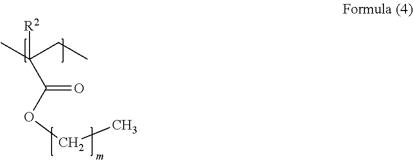

in the formula (4), R³ represents a hydrogen atom or a methyl group, and “m” represents an integer of from 10 to 24.

When the unit (c) has a long-chain alkyl group (alkyl group in which the number (m) of carbon atoms is 10 or more and 24 or less) having a structure similar to that of a side chain of the unit (a) for expressing the crystallinity of the crystalline resin, the crystalline resin and the resin S easily conform to each other, and the crystal of the crystalline resin and the resin S are easily brought into close contact with each other by an interaction between the long-chain alkyl groups. Accordingly, close adhesiveness between the core and the shell is improved to easily improve the durability of the toner. In addition, the crystalline resin and the resin S easily conform to each other, and hence the covering property of the resin S that is the shell is improved. Thus, the chargeability of the toner is stabilized to easily improve the initial fogging-suppressing property thereof.

In addition, it is preferred that the resin S show no clear endothermic peak in DSC measurement, that is, be an amorphous resin, and its glass transition temperature TgS be 30° C. or more and 90° C. or less.

When the resin S is amorphous, it becomes easier to suppress the endurance deterioration of the toner, thereby facilitating an improvement in durability thereof. When the TgS is 30° C. or more, the heat-resistant storage stability thereof is further improved, and when the TgS is 90° C. or less, the low-temperature fixability thereof is further improved.

The unit (c) can be incorporated into the resin S by subjecting a (meth)acrylic acid ester having an alkyl group having 10 or more and 24 or less carbon atoms as a polymerizable monomer to vinyl polymerization.

Examples of the (meth)acrylic acid ester having the alkyl group in which the number (m) of carbon atoms is 10 or more and 24 or less include (meth)acrylic acid esters each having a linear alkyl group having 10 or more and 24 or less carbon atoms [e.g., decyl (meth)acrylate, hendecyl (meth)acrylate, lauryl (meth)acrylate, tridecyl (meth)acrylate, tetradecyl (meth)acrylate, pentadecyl (meth)acrylate, cetyl (meth)acrylate, heptadecyl (meth)acrylate, stearyl (meth)acrylate, nonadecyl (meth)acrylate, eicosyl (meth)acrylate, heneicosyl (meth)acrylate, behenyl (meth)acrylate, lignoceryl (meth)acrylate, ceryl (meth)acrylate, octacosyl (meth)acrylate, and myricyl (meth)acrylate].

Of those, such an ester that the absolute value |n−m| of a difference between the number “n” of the carbon atoms of the long-chain alkyl group in the unit (a) and the number “m” of the carbon atoms of the long-chain alkyl group in the unit (c) is 10 or less is preferred.

When the “n” and the “m” are close to each other, an interaction between the long-chain alkyl groups becomes stronger to easily improve close adhesiveness between the crystalline resin and the resin S. Accordingly, it becomes easier for the shell to uniformly cover the core, and hence the initial fogging-suppressing property and durability of the toner are further improved. The |n−m| is more preferably 5 or less, and the |n−m| is still more preferably 0.

In the resin S, the units (c) may be used alone or in combination thereof.

The content of the unit (c) in the resin S is preferably 1.0 mass % or more and 30.0 mass % or less. When the content is 1.0 mass % or more, the crystalline resin and the resin S easily conform to each other, and the close adhesiveness therebetween is improved. Accordingly, it becomes easier to obtain a toner having an excellent endurance fogging-suppressing property. When the content is 30.0 mass % or less, the uniform covering property of the shell is improved to easily improve the durability. The content is preferably 1.0 mass % or more and 25.0 mass % or less, more preferably 5.0 mass % or more and 20.0 mass % or less. The content of the unit (c) is defined as the sum of the contents of all the units each represented by the formula (4). The same holds true for the case where a plurality of monomers (c) exist.

The resin S may contain one or a plurality of kinds of other units that do not satisfy the above-mentioned condition in addition to the unit (c). Examples of a polymerizable monomer for forming the other unit include the monomers of the unit (b) and the other units exemplified for the crystalline resin.

The content of the resin S in each of the toner particles is preferably 1.0 mass % or more and 20.0 mass % or less. When the content is 1.0 mass % or more and 20.0 mass % or less, the initial fogging-suppressing property, endurance fogging-suppressing property, and durability of the toner are further improved. The content is more preferably 2.0 mass % or more and 15.0 mass % or less, still more preferably 3.0 mass % or more and 8.0 mass % or less.

In addition, the weight-average molecular weight (MwS) of the tetrahydrofuran (THF) soluble matter of the resin S measured by gel permeation chromatography (GPC) is preferably 10,000 or more and 20,000 or less. When the MwS is 10,000 or more, the elasticity of the resin S becomes higher to easily improve the durability. When the MwS is 20,000 or less, the uniform covering property of the shell is improved to easily improve the fogging-suppressing properties.

The acid value Av of the resin S is preferably 5.0 mgKOH/g or more and 30.0 mgKOH/g or less. When the acid value is 5.0 mgKOH/g or more, the covering property of the shell is improved to easily improve the durability. The acid value is more preferably 10.0 mgKOH/g or more and 30.0 mgKOH/g or less.

The toner of the present disclosure may include any one of, for example, a vinyl-based resin, polyester, polyurethane, and an epoxy resin that do not correspond to the resins for forming the present disclosure.

Examples of a polymerizable monomer for forming the vinyl-based resin that does not correspond to the resins for forming the present disclosure include monomers except those for forming the unit (a) or (b) out of the above-mentioned monomers. Such monomers may be used in combination thereof as required.

The polyester may be obtained by a condensation polymerization reaction between a polyvalent carboxylic acid that is divalent or more and a polyhydric alcohol.

Examples of the polyvalent carboxylic acid include the following compounds.

Dibasic acids, such as succinic acid, adipic acid, sebacic acid, phthalic acid, isophthalic acid, terephthalic acid, malonic acid, and dodecenyl succinic acid, and anhydrides or lower alkyl esters thereof; and aliphatic unsaturated dicarboxylic acids, such as maleic acid, fumaric acid, itaconic acid, and citraconic acid. 1,2,4-Benzenetricarboxylic acid, 1,2,5-benzenetricarboxylic acid, and anhydrides or lower alkyl esters thereof. Those polyvalent carboxylic acids may be used alone or in combination thereof.

Examples of the polyvalent alcohol include the following compounds.

Alkylene glycols (ethylene glycol, 1,2-propylene glycol, and 1,3-propylene glycol); alkylene ether glycols (polyethylene glycol and polypropylene glycol); alicyclic diols (1,4-cyclohexanedimethanol); bisphenols (bisphenol A); and alkylene oxide (ethylene oxide and propylene oxide) adducts of alicyclic diols. The alkyl moiety of each of the alkylene glycol and the alkylene ether glycol may be linear or branched. In the present disclosure, an alkylene glycol having a branched structure may also be preferably used. Further examples include glycerin, trimethylolethane, trimethylolpropane, and pentaerythritol. Those polyhydric alcohols may be used alone or in combination thereof.

Monovalent acids, such as acetic acid and benzoic acid, and monohydric alcohols, such as cyclohexanol and benzyl alcohol, may each be used as required for the purpose of adjusting the acid value or hydroxyl value of the polyester.

Although a method of producing the polyester is not particularly limited, examples thereof include a transesterification method and a direct polycondensation method.

The polyurethane is obtained by a reaction between a diol component and a diisocyanate component.

Examples of the diisocyanate component include the following components: an aromatic diisocyanate having 6 or more and 20 or less carbon atoms (excluding carbon in an NCO group, the same holds true for the following), an aliphatic diisocyanate having 2 or more and 18 or less carbon atoms, and an alicyclic diisocyanate having 4 or more and 15 or less carbon atoms, and modified products of these diisocyanates (urethane group-, carbodiimide group-, allophanate group-, urea group-, biuret group-, uretdione group-, uretonimine group-, isocyanurate group-, or oxazolidone group-containing modified products, hereinafter also referred to as “modified diisocyanates”); and a mixture of two or more kinds thereof.

Examples of the aromatic diisocyanate include the following diisocyanates, m- and/or p-xylylene diisocyanate (XDI) and α,α,α′,α′-tetramethylxylylene diisocyanate.

In addition, examples of the aliphatic diisocyanate include the following diisocyanates. Ethylene diisocyanate, tetramethylene diisocyanate, hexamethylene diisocyanate (HDI), and dodecamethylene diisocyanate.

In addition, examples of the alicyclic diisocyanate include the following diisocyanates. Isophorone diisocyanate (IPDI), dicyclohexylmethane-4,4′-diisocyanate, cyclohexylene diisocyanate, and methylcyclohexylene diisocyanate.

Of those, an aromatic diisocyanate having 6 or more and 15 or less carbon atoms, an aliphatic diisocyanate having 4 or more and 12 or less carbon atoms, and an alicyclic diisocyanate having 4 or more and 15 or less carbon atoms are preferred, and XDI, IPDT, and HDI are particularly preferred.

In addition, an isocyanate compound that is trifunctional or more may be used in addition to the above-mentioned diisocyanate component.

The same alcohol as the dihydric alcohol that may be used in the polyester described above may be adopted as the diol component that may be used in the polyurethane.

The toner may include a wax as a release agent, and a known wax may be used without any particular limitation. A hydrocarbon-based wax or an ester wax is preferred. The use of the hydrocarbon-based wax or the ester wax can secure effective releasability.

Although the hydrocarbon-based wax is not particularly limited, examples thereof include the following waxes.

Aliphatic hydrocarbon-based wax: low-molecular-weight polyethylene, low-molecular-weight polypropylene, a low-molecular-weight olefin copolymer, a Fischer-Tropsch wax, or a wax obtained by subjecting any one of these compounds to oxidation or acid addition.

Herein, the ester wax only needs to have at least one ester bond in a molecule thereof, and any one of a natural ester wax and a synthetic ester wax may be used.

Although the ester wax is not particularly limited, examples thereof include the following waxes:

esters of monohydric alcohols and monocarboxylic acids, such as behenyl behenate, stearyl stearate, and palmityl palmitate;

esters of divalent carboxylic acids and monoalcohols, such as dibehenyl sebacate;

esters of dihydric alcohols and monocarboxylic acids, such as ethylene glycol distearate and hexanediol dibehenate;

esters of trihydric alcohols and monocarboxylic acids, such as glycerin tribehenate;

esters of tetrahydric alcohols and monocarboxylic acids, such as pentaerythritol tetrastearate and pentaerythritol tetrapalmitate;

esters of hexahydric alcohols and monocarboxylic acids, such as dipentaerythritol hexastearate, dipentaerythritol hexapalmitate, and dipentaerythritol hexabehenate;

esters of polyfunctional alcohols and monocarboxylic acids, such as polyglycerin behenate; and

natural ester waxes, such as carnauba wax and rice wax.

Of those, esters of hexahydric alcohols and monocarboxylic acids, such as dipentaerythritol hexastearate, dipentaerythritol hexapalmitate, and dipentaerythritol hexabehenate, are preferred.

The hydrocarbon-based wax or the ester wax may be used alone as the wax in the present disclosure, the hydrocarbon-based wax and the ester wax may be used in combination, or the two or more kinds of hydrocarbon-based or ester waxes may be used as a mixture.

The toner may include one or more kinds of additives selected from, for example, a colorant except the colorant according to the present disclosure, a magnetic material, a charge control agent, and a fluidizing agent as required, and the colorant is selected in terms of hue angle, chroma, brightness, light fastness, OHP transparency, and dispersibility in each of the toner particles.

When the colorant is not magnetic particles, the colorant is preferably incorporated in an amount of 1.0 part by mass or more and 20.0 parts by mass or less with respect to 100.0 parts by mass of the resin components. When magnetic particles are used as the colorant, their addition amount is preferably 40.0 parts by mass or more and 150.0 parts by mass or less with respect to 100.0 parts by mass of the resin components.

The following charge control agents may each be used as the charge control agent without any particular limitation. As examples of a negative charge control agent, there are given a monoazo metal compound, an acetylacetone metal compound, an aromatic oxycarboxylic acid, an aromatic dicarboxylic acid, and oxycarboxylic acid- and dicarboxylic acid-based metal compounds.

In addition, as examples of a positive charge control agent, there are given: a quaternary ammonium salt; a polymer-type compound having a quaternary ammonium salt in a side chain thereof; a guanidine compound; a pyridine-based compound; a nigrosine-based compound; and an imidazole compound.

The charge control agent is incorporated in an amount of preferably 0.01 part by mass or more and 20.0 parts by mass or less, more preferably 0.5 part by mass or more and 10.0 parts by mass or less with respect to 100.0 parts by mass of the resin component.

Examples of an external additive include the following products: inorganic fine particles selected from the group consisting of silica fine particles, alumina fine particles, and titania fine particles, or a composite oxide thereof. Examples of the composite oxide include silica aluminum fine particles and strontium titanate fine particles.

The external additive is incorporated in an amount of preferably 0.01 part by mass or more and 8.0 parts by mass or less, more preferably 0.1 part by mass or more and 4.0 parts by mass or less with respect to 100 parts by mass of the toner particles.

The toner particles may be produced by any one of conventionally known methods, such as a suspension polymerization method, an emulsion aggregation method, a dissolution suspension method, and a pulverization method, to the extent that the configuration of the specification is satisfied. Of those, a suspension polymerization method is preferred because the polar moiety of the sulfide structure is uniformly dispersed in the binder resin with ease, and the following production method is more preferably used.

Details about the suspension polymerization method are described.

For example, the above-mentioned resin S synthesized in advance is added to the mixture of the respective polymerizable monomers for producing the binder resin of the present disclosure, and the colorant of the present disclosure and any one of additives that may introduce the sulfide structure into the resin, such as mercaptans and/or thiuram disulfides, are added to the mixture. In addition, as required, any other materials, such as the wax, the charge control agent, and a crosslinking agent, are added to the mixture, and are uniformly dissolved or dispersed therein to prepare a polymerizable monomer composition.

After that, the polymerizable monomer composition is dispersed in an aqueous medium with a stirring unit or the like to prepare suspended particles of the polymerizable monomer composition. After that, the polymerizable monomers in the particles are polymerized with an initiator or the like to provide suspension polymerization method toner particles.

The toner is desirably obtained as follows: after the completion of the polymerization, the toner particles are filtered, washed, and dried by known methods, and the external additive is added thereto as required.

A known polymerization initiator may be used as the polymerization initiator. Examples thereof include: azo-based or diazo-based polymerization initiators, such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile; and peroxide-based polymerization initiators, such as benzoyl peroxide, t-butyl peroxy-2-ethylhexanoate, t-butyl peroxypivalate, t-butyl peroxyisobutyrate, t-butyl peroxyneodecanoate, methyl ethyl ketone peroxide, diisopropyl peroxycarbonate, cumene hydroperoxide, 2,4-dichlorobenzoyl peroxide, and lauroyl peroxide.

In addition, a known chain transfer agent or polymerization inhibitor may be used.

The aqueous medium may contain an inorganic or organic dispersion stabilizer. A known dispersion stabilizer may be used as the dispersion stabilizer.

Examples of the inorganic dispersion stabilizer include: phosphates, such as hydroxyapatite, tribasic calcium phosphate, dibasic calcium phosphate, magnesium phosphate, aluminum phosphate, and zinc phosphate; carbonates, such as calcium carbonate and magnesium carbonate; metal hydroxides, such as calcium hydroxide, magnesium hydroxide, and aluminum hydroxide; sulfates, such as calcium sulfate and barium sulfate; calcium metasilicate; bentonite; silica; and alumina.

Meanwhile, examples of the organic dispersion stabilizer include polyvinyl alcohol, gelatin, methyl cellulose, methylhydroxypropyl cellulose, ethyl cellulose, carboxymethyl cellulose sodium salt, polyacrylic acid and salts thereof, and starch.

When an inorganic compound is used as the dispersion stabilizer, a commercial product may be used as it is, but the inorganic compound may be produced and used in the aqueous medium for obtaining finer particles. In the case of, for example, calcium phosphate, such as hydroxyapatite or tribasic calcium phosphate, an aqueous solution of a phosphate and an aqueous solution of a calcium salt are desirably mixed under high stirring.

The aqueous medium may contain a surfactant. A known surfactant may be used as the surfactant. Examples thereof include: anionic surfactants, such as sodium dodecylbenzene sulfate and sodium oleate; cationic surfactants; amphoteric surfactants;

and nonionic surfactants.

[Various Measurement Methods]

Various measurement methods and the like are described below.

<Method of Measuring Contents of Various Units in Resin>

The contents of various units in a resin are measured by ¹H-NMR under the following conditions.

Measuring apparatus: FT NMR apparatus JNM-EX400 (manufactured by JEOL Ltd.)
Measurement frequency: 400 MHz
Pulse condition: 5.0 μs
Frequency range: 10,500 Hz
Number of scans: 64 times
Measurement temperature: 30° C.
Sample: 50 mg of a measurement sample is loaded into a sample tube having an inner diameter of 5 mm, and deuterated chloroform (CDCh) is added as a solvent to the tube. The sample is dissolved in the solvent in a thermostat at 40° C. to prepare a solution.

The resultant ¹H-NMR chart is analyzed, and the structures of the respective units are identified. Herein, the measurement of the content of the unit (a) in the crystalline resin is described as an example. In the resultant ¹H-NMR chart, a peak independent of a peak assigned to a constituent for any other unit is selected from peaks assigned to constituents for the unit (a), and the integrated value S1 of the peak is calculated. The integrated value of each of the other units in the resin is similarly calculated.

When the units for forming the crystalline resin are the unit (a) and one kind of other unit, the content of the unit (a) is determined by using the above-mentioned integral value S1 and the integral value S2 of the peak of the other unit as described below. “n1” and “n2” each represent the number of hydrogen atoms in the constituent to which the peak to which attention has been paid for the corresponding moiety is assigned.

Content (mol %) of unit (a)={(S1/n1)/((S1/n1)+(S2/n2))}×100

The content of the unit (a) may be similarly calculated even when two or more kinds of other units are present.

When a polymerizable monomer in which a constituent except a vinyl group is free of any hydrogen atom is used, the measurement is performed by using ¹¹C-NMR through use of ¹³C as a measurement atomic nucleus in a single-pulse mode, and the content is calculated in the same manner by ¹H-NMR.

The content (mol %) of each unit calculated by the above-mentioned method is converted into the unit of mass % by multiplying the content of the unit by the molecular weight of the unit.

In addition, when NMR is measured by using the toner as a sample, the peaks of the wax and a resin except the crystalline resin may overlap each other to preclude the observation of an independent peak. Thus, the content of each unit in the binder resin cannot be calculated in some cases. In such cases, analysis may be performed as follows: a binder resin is produced by performing the same production without using the wax and the other resin, and the resin is regarded as the crystalline resin. The above-mentioned resin S is subjected to measurement by using the same method.

<Method of Measuring Weight-Average Molecular Weight (Mw) of Resin>

The weight-average molecular weight (Mw) of a resin is measured by gel permeation chromatography (GPC) as described below.

First, a sample is dissolved in tetrahydrofuran (THF) at room temperature over 24 hours. Then, the resultant solution is filtered with a solvent-resistant membrane filter “Myshoridisk” (manufactured by Tosoh Corporation) having a pore diameter of 0.2 μm to provide a sample solution. The concentration of a THF-soluble component in the sample solution is adjusted to 0.8 mass %. Measurement is performed with the sample solution under the following conditions.

Apparatus: HLC 8120 GPC (detector: RI) (manufactured by Tosoh Corporation)
Column: Septuplicate of Shodex KF-801, 802, 803, 804, 805, 806, and 807 (manufactured by Showa Denko K.K.)

### Eluent: Tetrahydrofuran (THF)

Flow rate: 1.0 mL/min
Oven temperature: 40.0° C.
Sample injection amount: 0.10 mL

At the time of the calculation of the molecular weight of the sample, a molecular weight calibration curve prepared with standard polystyrene resins (e.g., product names “TSK Standard Polystyrenes F-850, F-450, F-288, F-128, F-80, F-40, F-20, F-10, F-4, F-2, F-1, A-5000, A-2500, A-1000, and A-500” manufactured by Tosoh Corporation) is used.

<Methods of Measuring Maximum Endothermic Peak and Endothermic Quantity>

The melting point and endothermic quantity of the toner or the resin are measured using DSC Q2000 (manufactured by TA Instruments, Inc.) under the following conditions.

Rate of temperature increase: 10° C./min
Measurement start temperature: 20° C.
Measurement end temperature: 180° C.

The melting points of indium and zinc are used for the temperature correction of the detecting portion of the calorimeter, and the heat of fusion of indium is used for heat quantity correction.

Specifically, about 5 mg of a sample is precisely weighed, loaded into a pan made of aluminum, and subjected to differential scanning calorimetry. An empty pan made of silver is used as a reference. As a temperature increase process, the temperature of the sample is increased to 180° C. at a rate of 10° C./min. Then, a peak temperature and an endothermic quantity are calculated from each peak.

When the toner is used as a sample, in the case where its maximum endothermic peak (typically an endothermic peak considered to be derived from the crystalline resin) does not overlap any other endothermic peak derived from a release agent or the like, the endothermic quantity only needs to be determined by treating a temperature at the intact endothermic peak as the highest endothermic peak temperature of the toner.

Meanwhile, when the other endothermic peak derived from the release agent or the like overlaps the maximum endothermic peak, the endothermic peak derived from the release agent or the like needs to be subtracted.

An endothermic peak derived from the binder resin may be obtained through, for example, the subtraction of the endothermic peak derived from the release agent by the following method.

First, the DSC measurement of the release agent alone is separately performed to determine the endothermic characteristic thereof. Next, the content of the release agent in the toner is determined. The content of the release agent in the toner may be measured by known structural analysis. After that, an endothermic quantity resulting from the release agent is calculated from the content of the release agent in the toner, and the quantity only needs to be subtracted from the endothermic peak obtained in the measurement.

When the release agent is liable to be compatible with a binder resin component, an endothermic quantity resulting from the release agent, which is calculated after the content of the release agent has been multiplied by the compatibility ratio thereof, needs to be subtracted. The compatibility ratio is calculated from a value obtained as follows: the molten mixture of the resin components and the release agent are melted and mixed at the same ratio as the percentage content of the release agent; the endothermic quantity of the resultant mixture is determined; and the endothermic quantity is divided by a theoretical endothermic quantity calculated from the endothermic quantity of the molten mixture and the endothermic quantity of the release agent alone determined in advance.

With regard to the endothermic quantity, an endothermic quantity from a temperature lower than the corresponding endothermic peak temperature Tp by 20.0° C. to a temperature higher than the Tp by 10.0° C. is calculated with DSC analysis software.

<Measurement of Glass Transition Temperature>

A glass transition temperature Tg is measured with a differential scanning calorimeter “Q2000” (manufactured by TA Instruments, Inc.) in conformity with ASTM D3418-82. The melting points of indium and zinc are used for the temperature correction of the detecting portion of the calorimeter, and the heat of fusion of indium is used for heat quantity correction.

Specifically, about 2 mg of a sample is precisely weighed, and the sample is loaded into a pan made of aluminum. An empty pan made of aluminum is used as a reference, and the glass transition temperature of the sample is measured in the measurement temperature range of from −10° C. to 200° C. at a rate of temperature increase of 10° C./min. In the measurement, the temperature of the sample is increased to 200° C. once, and is subsequently decreased to −10° C., followed by the performance of a temperature increase again. A change in specific heat is obtained in the temperature range of from 30° C. to 100° C. in the second temperature increase process. The point of intersection of a line, which is intermediate between baselines before and after the appearance of the change in specific heat at this time, and the differential thermal curve of the sample is defined as the glass transition temperature Tg.

<Measurement of Weight-Average Particle Diameter (D4) of Toner>

The weight-average particle diameter (D4) of the toner is calculated as described below. A precision particle size distribution-measuring apparatus based on a pore electrical resistance method provided with a 100 μm aperture tube “Coulter Counter Multisizer 3” (trademark, manufactured by Beckman Coulter, Inc.) is used as a measuring apparatus. Dedicated software included therewith “Beckman Coulter Multisizer 3 Version 3.51” (manufactured by Beckman Coulter, Inc.) is used for setting measurement conditions and analyzing measurement data. Measurement is performed with the number of effective measurement channels of 25,000.

An electrolyte aqueous solution prepared by dissolving special-grade sodium chloride in ion-exchanged water so as to have a concentration of 1.0%, such as “ISOTON II” (manufactured by Beckman Coulter, Inc.), may be used in the measurement.

The dedicated software is set as described below prior to the measurement and the analysis.

In the “change standard measurement method (SOMME)” screen of the dedicated software, the total count number of a control mode is set to 50,000 particles, the number of times of measurement is set to 1, and a value obtained by using “standard particles each having a particle diameter of 10.0 μm” (manufactured by Beckman Coulter, Inc.) is set as a Kd value. A threshold and a noise level are automatically set by pressing a “threshold/noise level measurement” button. In addition, a current is set to 1,600 μA, a gain is set to 2, and an electrolyte solution is set to ISOTON II, and a check mark is placed in a check box as to “whether the aperture tube is flushed after the measurement.”

In the “setting for conversion from pulse to particle diameter” screen of the dedicated software, a bin interval is set to a logarithmic particle diameter, the number of particle diameter bins is set to 256, and a particle diameter range is set to the range of from 2 μm to 60 μm.

A specific measurement method is as described below.

(1) 200.0 mL of the electrolyte aqueous solution is charged into a 250 mL round-bottom beaker made of glass dedicated for the Multisizer 3. The beaker is set in a sample stand, and the electrolyte aqueous solution in the beaker is stirred with a stirrer rod at 24 rotations/sec in a counterclockwise direction. Then, dirt and bubbles in the aperture tube are removed by the “aperture tube flush” function of the dedicated software.

(2) 30.0 mL of the electrolyte aqueous solution is charged into a 100 mL flat-bottom beaker made of glass. 0.3 mL of a diluted solution prepared by diluting “Contaminon N” (a 10% aqueous solution of a neutral detergent for washing a precision measuring device formed of a nonionic surfactant, an anionic surfactant, and an organic builder and having a pH of 7 manufactured by Wako Pure Chemical Industries, Ltd.) with ion-exchanged water by three mass fold is added as a dispersant to the electrolyte aqueous solution.

(3) An ultrasonic dispersing unit “Ultrasonic Dispersion System Tetra 150” (manufactured by Nikkaki Bios Co., Ltd.) having an electrical output of 120 W in which two oscillators each having an oscillatory frequency of 50 kHz are built so as to be out of phase by 1800 is prepared. 3.3 L of ion-exchanged water is charged into the water tank of the ultrasonic dispersing unit, and 2.0 mL of the Contaminon N is charged into the water tank.

(4) The beaker in the section (2) is set in the beaker fixing hole of the ultrasonic dispersing unit, and the ultrasonic dispersing unit is operated. Then, the height position of the beaker is adjusted in order that the liquid surface of the electrolyte aqueous solution in the beaker may resonate with an ultrasonic wave from the ultrasonic dispersing unit to the fullest extent possible.

(5) 10 mg of toner particles are gradually added to and dispersed in the electrolyte aqueous solution in the beaker in the section (4) under a state in which the electrolyte aqueous solution is irradiated with the ultrasonic wave. Then, the ultrasonic dispersion treatment is continued for an additional 60 seconds. The temperature of water in the water tank is appropriately adjusted to 10° C. or more and 40° C. or less in the ultrasonic dispersion.

(6) The electrolyte aqueous solution in the section (5) in which the toner particles have been dispersed is added dropwise with a pipette to the round-bottom beaker in the section (1) placed in the sample stand, and the concentration of the particles to be measured is adjusted to 5%. Then, measurement is performed until the particle diameters of 50,000 particles are measured.

(7) The measurement data is analyzed with the dedicated software included with the apparatus, and the weight-average particle diameter (D4) is calculated. An “average diameter” on the “analysis/volume statistics (arithmetic average)” screen of the dedicated software when the dedicated software is set to show a graph in a vol % unit is the weight-average particle diameter (D4).

<Measurement of Acid Value of Resin>

An acid value is the weight (mg) of potassium hydroxide required for neutralizing an acid in 1 g of a sample. The acid value of a resin A in the present disclosure, which is measured in conformity with JIS K 0070-1992, is specifically measured in accordance with the following procedure.

(1) Preparation of Reagent

1.0 g of phenolphthalein is dissolved in 90 mL of ethyl alcohol (95 vol %), and ion-exchanged water is added to the solution so that the total volume may be 100 mL. Thus, a phenolphthalein solution is obtained.

7 g of special-grade potassium hydroxide is dissolved in 5 mL of water, and ethyl alcohol (95 vol %) is added to the solution so that the total volume may be 1 L. The mixture is loaded into an alkali-resistant container so as not to be brought into contact with a carbon dioxide gas or the like, and is left to stand for 3 days. After that, the mixture is filtered to provide a potassium hydroxide solution. The resultant potassium hydroxide solution is stored in an alkali-resistant container. The factor of the potassium hydroxide solution is determined as follows: 25 mL of 0.1 mol/L hydrochloric acid is loaded into an Erlenmeyer flask, and several drops of the phenolphthalein solution are added thereto; and the mixture is titrated with the potassium hydroxide solution, and the factor is determined from the amount of the potassium hydroxide solution required for neutralization. A product produced in conformity with JIS K 8001-1998 is used as the 0.1 mol/L hydrochloric acid.

(2) Operation

(A) Main Test

2.0 g of a toner sample obtained by melting and kneading raw materials, and pulverizing the kneaded product is precisely weighed in a 200 mL Erlenmeyer flask, and 100 mL of a mixed solution of toluene and ethanol (2:1) is added to dissolve the sample over 5 hours. Next, several drops of the phenolphthalein solution are added as an indicator to the solution, and the solution is titrated with the potassium hydroxide solution. The endpoint of the titration is defined as the time point at which the pale pink color of the indicator continues for 30 seconds.

(B) Blank Test

The same titration as that in the above-mentioned operation is performed except that no sample is used (i.e., only the mixed solution of toluene and ethanol (2:1) is used).

(3) The obtained results are substituted into the following equation to calculate the acid value:

A=[(C−B)×f×5.61]/S

where A represents the acid value (mgKOH/g), B represents the addition amount (mL) of the potassium hydroxide solution in the blank test, C represents the addition amount (mL) of the potassium hydroxide solution in the main test, “f” represents the factor of the potassium hydroxide solution, and S represents the mass (g) of the sample.

<Method of Calculating SP Value>

The SPa and the SPb were determined in accordance with a calculation method proposed by Fedors as described below.

Evaporation energy (Δci) (cal/mol) and a molar volume (Δvi) (cm³/mol) are determined from a table shown in “Polym. Eng. Sci., 14(2), 147-154 (1974)” for an atom or an atomic group in a molecular structure in a state in which the double bond of each polymerizable monomer is cleaved by its polymerization, and a value calculated from the expression “4.184×ΣΔei/ΣΔvi)^{0.5}” is defined as an SP value (J/cm³)^{0.5}.

The SP values, that is, SPa and SPb of a resin are calculated from the following equation (6) as follows: the evaporation energies (Δci) and molar volumes (Δvi) of units for forming the resin are determined for each of the units; the product of each of the evaporation energy and molar volume of each of the units, and the molar ratio (j) thereof in the resin is calculated; and the SP values are each determined by dividing the total sum of the evaporation energies of the respective units by the total sum of the molar volumes thereof.

SPs={(Σj×ΣΔei)/(Σj×ΣΔvi)}^{1/2} Equation (6)

The SP values are calculated for the respective resins as described above.

The unit of an SP value may be converted into the unit of (cal/cm³)^{0.5} by the equation “1 (J/cm³)^{0.5}=2.045 (cal/cm³)^{0.5}.”

### EXAMPLES

The present disclosure is specifically described below by way of Examples. However, the present disclosure is by no means limited thereto. In the following formulations, the term “part(s)” means “part(s) by mass” unless otherwise specified.

<Production Example of Resin S1>

The following materials were loaded into a reaction vessel including a reflux condenser, a stirring machine, a temperature gauge, and a nitrogen-introducing tube under a nitrogen atmosphere.

| | | |
|---|---|---|
| Solvent: | | |
| Toluene | 100.0 | parts |
| Monomers: | | |
| Styrene | 64.0 | parts |
| Behenyl acrylate | 18.0 | parts |
| Acrylonitrile | 15.0 | parts |
| Methacrylic acid | 3.0 | parts |
| t-Butyl peroxypivalate (manufactured | 5.0 | parts |
| by NOF Corporation: PERBUTYL PV) | | |
| serving as a polymerization initiator | | |

While the materials in the reaction vessel were stirred at 200 rpm, the materials were heated to 70° C. and subjected to a polymerization reaction for 12 hours. Thus, such a dissolved liquid that the polymer of a monomer composition was dissolved in toluene was obtained. Subsequently, the temperature of the dissolved liquid was reduced to 25° C., and then the dissolved liquid was loaded into 1,000.0 parts of methanol while methanol was stirred. Thus, methanol-insoluble matter was precipitated. The resultant methanol-insoluble matter was separated by filtration, and was washed with methanol, followed by vacuum drying at 40° C. for 24 hours. Thus, a shell-use resin S1 was obtained. The physical property value of the resin S1 is shown in Table 1.

### Production Examples of Resins S2 to S10

Resins S2 to S10 were each obtained in the same manner as in the method of producing the resin S1 except that the polymerizable monomers and the loading amounts of the polymerizable monomers were changed as shown in Table 1. The physical property values of the resins S2 to S10 are shown in Table 1.

### Production Example of Resin S11

The following materials were loaded into a pressurizable reaction vessel including a reflux condenser, a stirring machine, a temperature gauge, a nitrogen-introducing tube, a dropping device, and a decompressor, and the mixture was heated to a reflux temperature while being stirred.

| | | |
|---|---|---|
| Solvents: | | |
| Methanol | 250 | parts |
| 2-Butanone | 150 | parts |
| 2-Propanol | 100 | parts |
| Monomers: | | |
| Styrene | 85 | parts |
| Butyl acrylate | 12 | parts |
| 2-Acrylamido-2-methylpropanesulfonic | 3 | parts |
| acid (hereinafter referred to as “AMPS”) | | |

A solution obtained by diluting 0.28 part of tert-butyl peroxy-2-ethylhexanoate that was a polymerization initiator with 20 parts of 2-butanone was added dropwise to the vessel over 30 minutes, and the mixture was further stirred for 5 hours to initiate polymerization.

A polymer obtained after the evaporation of the polymerization solvent under reduced pressure was coarsely pulverized into 100 μm or less with a cutter mill mounted with a 150-mesh screen. The resultant resin S11 had a Tg of about 70° C. The physical property of the resin S11 is shown in Table 1.

TABLE 1

| | Shell-use resin | | | | | | | | |
|---|---|---|---|---|---|---|---|---|---|
| | First unit | | Second anit | | Third unit | | Fourth unit | | Acid value |
| | Kind of | | Kind of | | Kind of | | Kind of | | Av |
| | monomer | mass % | monomer | mass % | monomer | mass % | monomer | mass % | mgKOH/g |
| Resin S1 | BEA | 18.0 | AN | 15.0 | MAA | 3.0 | St | 64.0 | 16.5 |
| Resin S2 | BEA | 18.0 | AN | 15.0 | MAA | 1.0 | St | 66.0 | 5.1 |
| Resin S3 | BEA | 18.0 | AN | 15.0 | MAA | 0.9 | St | 66.1 | 4.8 |
| Resin S4 | BEA | 18.0 | AN | 15.0 | MAA | 5.0 | St | 62.0 | 30.0 |
| Resin S5 | BEA | 18.0 | AN | 15.0 | MAA. | 5.8 | St | 61.2 | 32.0 |
| Resin S6 | BEA | 30.0 | AN | 5.0 | MAA | 3.0 | St | 62.0 | 16.5 |
| Resin S7 | BEA | 32.0 | AN | 5.0 | MAA | 3.0 | St | 60.0 | 16.5 |
| Resin S8 | BEA | 1.0 | AN | 15.0 | MAA | 3.0 | St | 81.0 | 16.5 |
| Resin S9 | BEA | 0.0 | AN | 15.0 | MAA | 3.0 | St | 82.0 | 16.5 |
| Resin S10 | LAA | 18.0 | AN | 15.0 | MAA. | 3.0 | St | 64.0 | 16.5 |
| Resin S11 | St | 85.0 | BA | 12.0 | AMPS | 3.0 | — | — | — |

BEA: behenyl acrylate
LAA: lauryl acrylate
AN: acrylonitrile
MA.A.: methacrylic acid
St: styrene
BA: butyl acrylate
AMPS: 2-acrylamido-2-methylpropanesulfonic acid

### Production Example of Toner 1

[Production of Toner by Suspension Polymerization Method]

(Preparation of Toner Particles 1)

The following materials were loaded into an attritor (manufactured by Nippon Coke & Engineering Co., Ltd.).

| | | |
|---|---|---|
| Methacrylonitrile | 29.91 | parts |
| Styrene | 6.98 | parts |
| Ethyl methacrylate | 12.96 | parts |
| Polymethyl methacrylate having a | 0.3 | part |
| methacryloyl group at a terminal | | |
| thereof (macromonomer, manufactured | | |
| by Toagosei Co., Ltd., AA-6, Mn: 6,000) | | |
| Colorant (carbon black) | 8.0 | parts |

The materials were dispersed with zirconia beads each having a diameter of 5 mm at 200 rpm for 2 hours to provide a raw material dispersion liquid.

Meanwhile, 735.0 parts of ion-exchanged water and 16.0 parts of trisodium phosphate dodecahydrate were loaded into a vessel including a high-speed stirring device HOMOMIXER (manufactured by PRIMIX Corporation) and a temperature gauge, and a temperature in the vessel was increased to 60° C. while the mixture was stirred at 12,000 rpm. Subsequently, an aqueous solution of calcium chloride obtained by dissolving 9.0 parts of calcium chloride dihydrate in 65.0 parts of ion-exchanged water was loaded into the vessel, and the mixture was stirred at 12,000 rpm for 30 minutes while the temperature was held at 60° C. Thus, such an aqueous medium that a dispersion stabilizer including hydroxyapatite was dispersed in water was obtained.

Subsequently, the raw material dispersion liquid was transferred to a vessel including a stirring device and a temperature gauge, and a temperature in the vessel was increased to 60° C. while the mixture was stirred at 100 rpm. The following materials were loaded into the vessel.

| | | |
|---|---|---|
| Behenyl acrylate | 49.85 | parts |
| Resin S1 | 3.8 | parts |
| t-Dodecylmercaptan | 1.0 | part |
| Wax (dipentaerythritol hexastearate) | 9.0 | parts |

The mixture was stirred at 100 rpm for 30 minutes while the temperature was held at 60° C. After that, 5.0 parts of t-butyl peroxypivalate (manufactured by NOF Corporation, PERBUTYL PV) was added as a polymerization initiator to the mixture, and the whole was further stirred for 1 minute, followed by loading into the aqueous medium stirred with the above-mentioned high-speed stirring device at 12,000 rpm. The mixture was continuously stirred with the high-speed stirring device at 12,000 rpm for 20 minutes while the temperature in the vessel including the device was held at 60° C. Thus, a granulated liquid was obtained.

The granulated liquid was transferred to a reaction vessel including a reflux condenser, a stirring machine, a temperature gauge, and a nitrogen-introducing tube, and a temperature in the vessel was increased to 70° C. while the granulated liquid was stirred under a nitrogen atmosphere at 150 rpm. The granulated liquid was subjected to a polymerization reaction at 150 rpm for 12 hours while the temperature was held at 70° C. Thus, a toner particle dispersion liquid was obtained.

The resultant toner particle dispersion liquid was cooled to 45° C. while being stirred at 150 rpm. After that, the dispersion liquid was subjected to heat treatment for 5 hours while the temperature was maintained at 45° C. After the heat treatment, the dispersion liquid was cooled to 30° C., and dilute hydrochloric acid was added until the pH of the dispersion liquid became 1.5 while the stirring was held. Thus, the above-mentioned dispersion stabilizer was dissolved. After that, the solid content was separated by filtration, and was sufficiently washed with ion-exchanged water, followed by vacuum drying at 30° C. for 24 hours. Thus, toner particles 1 each containing a binder resin 1 were obtained.

In addition, a binder resin 1′ was obtained in exactly the same manner as in the method of producing the toner particles 1 described above except that carbon black, the resin S1, and the wax were not used. The binder resin 1′ had a weight-average molecular weight (Mw) of 56,000, a melting point of 63° C., and an acid value of 0.0 mgKOH/g. The NMR analysis of the binder resin 1′ showed that the resin contained 49.8 mass % of a unit derived from behenyl acrylate, 29.9 mass % of a unit derived from methacrylonitrile, 7.0 mass % of a unit derived from styrene, 13.0 mass % of a unit derived from ethyl methacrylate, and 0.3 mass % of a unit derived from the polymethyl methacrylate having a methacryloyl group at a terminal thereof.

In addition, measurement with a combustion ion chromatograph recognized that a sulfur element derived from the mercaptan was incorporated into the binder resin 1′ as formulated. The measurement conditions of the combustion ion chromatograph are as described below.

Apparatus: combustion apparatus (AQF-100), Mitsubishi Chemical Analytech, Co., Ltd., and ion chromatograph (ICS-2000), Thermo Fisher Scientific
Sample amount: about 20 mg
Combustion conditions: AQF: Inlet: 900° C., Outlet: 1,000° C., Gas: Ar/O₂: 200 ml/min, O₂: 400 ml/min, Ar: 150 ml/min
ABC: 1st: 120 mm, 120 sec, 2nd: 140 mm, 160 sec, 3rd: 150 mm, 150 sec, End: 360 sec,

### Cool Time: 30 sec

Boat Speed: 10 mm/sec
GA-100: absorption liquid amount: 10 ml
Absorption liquid: H₂O₂, 30 ppm, internal standard PO₄: 1 ppm
Analysis conditions: column: AS-17, temperature: 35° C., liquid feeding conditions: 0-15 min KOH 1 mmol-+40 mmol gradient

Under the measurement conditions, a calibration curve was prepared with a standard sample, and the amount of the sulfur element in the resin was determined.

In addition, the binder resin 1 in each of the toner particles 1 and the binder resin 1′ were judged to have the same physical properties because the resins were similarly produced.

2.0 Parts of silica fine particles (subjected to hydrophobic treatment with hexamethyldisilazane, number-average particle diameter of primary particles: 10 nm) were added as an external additive to 100.0 parts of the toner particles 1, and the particles were mixed with an FM MIXER (manufactured by Nippon Coke & Engineering Co., Ltd.) at 3,000 rpm for 15 minutes to provide a toner 1. SP values concerning the present disclosure are shown in Table 3. The physical properties of the toner 1 are shown in Table 4.

### Production Examples of Toners 2 to 29, 35, and 36

Toner particles 2 to 29, 35, and 36 were each obtained in exactly the same manner as in the production example of the toner 1 except that the kinds and amounts of the materials to be used were changed as shown in Table 2.

Further, the same external addition as that of the toner 1 was performed to provide toners 2 to 29, 35, and 36. SP values concerning the present disclosure are shown in Table 3. The physical properties of the toners are shown in Table 4.

### Production Example of Toner 30

[Production of Toner by Emulsion Aggregation Method]

(Preparation of Polymer Dispersion Liquid 1)

Under a nitrogen atmosphere, the following materials were loaded into a reaction vessel including a reflux condenser, a stirring machine, a temperature gauge, and a nitrogen-introducing tube.

| | | |
|---|---|---|
| Toluene | 100.00 | parts |
| Monomer composition | 100.00 | parts |
| Behenyl acrylate | 50.00 | parts |
| Methacrylonitrile | 30.00 | parts |
| Styrene | 7.00 | parts |
| Ethyl methacrylate | 13.00 | parts |
| t-Dodecylmercaptan | 1.0 | part |
| t-Butyl peroxypivalate | 5.0 | parts |

The above-mentioned respective components were mixed to prepare a monomer solution. A surfactant aqueous solution obtained by dissolving 10 parts of an anionic surfactant (manufactured by DKS Co., Ltd.: NEOGEN RK) in 1,130 parts of ion-exchanged water, and the monomer solution were loaded into a two-necked flask, and were stirred with a homogenizer (manufactured by IKA: ULTRA-TURRAX T50) at a number of revolutions of 10,000 r/min to be emulsified.

After that, the inside of the flask was purged with nitrogen, and the flask was heated in a water bath until the temperature of its contents became 70° C. while the contents were slowly stirred. Thus, polymerization was initiated.

After the reaction had been continued for 8 hours, the reaction liquid was cooled to room temperature, and its concentration was adjusted with ion-exchanged water. Thus, an aqueous dispersion liquid containing polymer fine particles 1 at a concentration of 20 mass % (polymer dispersion liquid 1) was obtained.

The 50% particle diameter (D50) of the polymer fine particles 1 on a volume distribution basis was measured with a dynamic light scattering-type particle size distribution meter NANOTRAC UPA-EX150 (manufactured by Nikkiso Co., Ltd.), and was found to be 0.40 μm.

(Preparation of Shell-use Resin Dispersion Liquid 1)

| | |
|---|---|
| Toluene (manufactured by Wako | 300 parts |
| Pure Chemical Industries, Ltd.) | |
| Resin S1 | 100 parts |

The above-mentioned materials were weighed and mixed, and dissolved at 90° C.

Separately, 5.0 parts of sodium dodecylbenzenesulfonate and 10.0 parts of sodium laurate were added to 700 parts of ion-exchanged water and dissolved therein by heating at 90° C.

Then, the toluene solution and the aqueous solution were mixed with each other, and the mixture was stirred at 7,000 rpm with an ultrahigh-speed stirring apparatus T.K. Robomix (manufactured by Primix Corporation). Further, the mixture was emulsified at a pressure of 200 MPa with a high-pressure impact-type dispersing machine Nanomizer (manufactured by Yoshida Kikai Co., Ltd.). After that, toluene was removed with an evaporator, and concentration adjustment was performed with ion-exchanged water to provide an aqueous dispersion liquid of a shell-use resin dispersion liquid 1 having a concentration of 20 mass %.

The 50% particle diameter (D50) of the shell-use resin dispersion liquid 1 on a volume distribution basis was measured using a dynamic light scattering-type particle size distribution meter NANOTRAC UPA-EX150 (manufactured by Nikkiso Co., Ltd.), and was found to be 0.40 μm.

<Preparation of Wax Dispersion Liquid 1>

| | | |
|---|---|---|
| Fischer-Tropsch wax (manufactured by Nippon | 100.00 | parts |
| Seiro Co., Ltd.: HNP-51, melting point: 74° C.) | | |
| Anionic surfactant Neogen RK | 5.00 | parts |
| (manufactured by DKS Co., Ltd.) | | |
| Ion-exchanged water | 395.00 | parts |

The above-mentioned materials were weighed and loaded into a mixing vessel with a stirring apparatus, and then heated to 90° C. and subjected to dispersion treatment for 60 minutes by being circulated in Clearmix W-Motion (manufactured by M Technique Co., Ltd.). The conditions of the dispersion treatment were set as described below.
Rotor outer diameter: 3 cm
Clearance: 0.3 mm
Number of rotor rotations: 19,000 r/min
Number of screen rotations: 19,000 r/min

After the dispersion treatment, the resultant was cooled to 40° C. under the cooling treatment conditions of a number of rotor rotations of 1,000 r/min, a number of screen rotations of 0 r/min, and a cooling rate of 10° C./min to provide a wax dispersion liquid 1 containing wax fine particles 1 at a concentration of 20 mass %.

The 50% particle diameter (D50) of the wax fine particles 1 on a volume distribution basis was measured with a dynamic light scattering-type particle size distribution meter NANOTRAC UPA-EX150 (manufactured by Nikkiso Co., Ltd.), and was found to be 0.15 μm.

<Preparation of Colorant Dispersion Liquid 1>

| | | |
|---|---|---|
| Colorant (yellow pigment PY74) | 50.00 | parts |
| Anionic surfactant Neogen RK | 7.50 | parts |
| (manufactured by DKS Co., Ltd.) | | |
| Ion-exchanged water | 442.50 | parts |

The above-mentioned materials were weighed and mixed, and dispersed for 1 hour with a high-pressure impact-type dispersing machine Nanomizer (manufactured by Yoshida Kikai Co., Ltd.) to provide a colorant dispersion liquid 1 containing colorant fine particles 1 at a concentration of 10 mass % in which the colorant was dispersed.

The 50% particle diameter (D50) of the colorant fine particles 1 on a volume distribution basis was measured with a dynamic light scattering-type particle size distribution meter NANOTRAC UPA-EX150 (manufactured by Nikkiso Co., Ltd.), and was found to be 0.20 μm.

(Production of Toner 30)

| | | |
|---|---|---|
| Polymer dispersion liquid 1 | 400.00 | parts |
| Wax dispersion liquid 1 | 225.00 | parts |
| Colorant dispersion liquid 1 | 300.00 | parts |
| Ion-exchanged water | 160.00 | parts |

The above-mentioned materials were loaded into a round flask made of stainless steel, and were mixed. Subsequently, the mixture was dispersed with a homogenizer ULTRA-TURRAX T50 (manufactured by IKA) at 5,000 r/min for 10 minutes. A 1.0% aqueous solution of nitric acid was added to adjust the pH to 3.0, and then the mixture was heated to 58° C. in a water bath for heating while the number of rotations was appropriately adjusted so as to stir the mixed liquid with a stirring blade.

The volume-average particle diameter of formed aggregated particles was appropriately determined with a Coulter Multisizer 111, and at the time when aggregated particles having a volume-average particle diameter of about 6.0 μm were formed, the pH was adjusted to 9.0 with a 5% aqueous solution of sodium hydroxide.

After that, while stirring was continued, heating was performed to 75° C. Then, the mixture was held at 75° C. for 1 hour so that the aggregated particles were fused.

After that, 64.00 parts (solid content: 4.00 parts) of the shell-use resin dispersion liquid 1 was added to the aggregated particles, and the mixture was held at 75° C. for 1 hour so that the aggregated particles were fused.

After that, the resultant was cooled to 50° C. and held for 3 hours to promote the crystallization of the polymer.

After that, the resultant was cooled to 25° C., and subjected to filtration and solid-liquid separation, followed by washing with ion-exchanged water.

After the completion of the washing, the resultant was dried with a vacuum dryer to provide toner particles 30 having a weight-average particle diameter (D4) of 6.2 m.

The same external addition as that of Example 1 to the toner particles 30 was performed to provide a toner 30. SP values concerning the present disclosure are shown in Table 3. The physical properties of the toner are shown in Table 4.

### Production Examples of Toners 31 to 34

(Preparation of Polymer Dispersion Liquid 2)

Under a nitrogen atmosphere, the following materials were loaded into a reaction vessel including a reflux condenser, a stirring machine, a temperature gauge, and a nitrogen-introducing tube.

| | | |
|---|---|---|
| Toluene | 100.00 | parts |
| Monomer composition | 100.00 | parts |
| Behenyl acrylate | 50.00 | parts |
| Methacrylonitrile | 30.00 | parts |
| Styrene | 7.00 | parts |
| Ethyl methacrylate | 13.00 | parts |
| t-Dodecylmercaptan | 1.0 | part |
| t-Butyl peroxypivalate | 5.0 | parts |

The above-mentioned respective components were mixed to prepare a monomer solution. A surfactant aqueous solution obtained by dissolving 10 parts of an anionic surfactant (manufactured by DKS Co., Ltd.: NEOGEN RK) in 1,130 parts of ion-exchanged water, and the monomer solution were loaded into a two-necked flask, and were stirred with a homogenizer (manufactured by IKA: ULTRA-TURRAX T50) at a number of revolutions of 10,000 r/min to be emulsified.

After that, the inside of the flask was purged with nitrogen, and the flask was heated in a water bath until the temperature of its contents became 70° C. while the contents were slowly stirred. Thus, polymerization was initiated.

After the reaction had been continued for 8 hours, the reaction liquid was cooled to room temperature, and its concentration was adjusted with ion-exchanged water. Thus, an aqueous dispersion liquid containing polymer fine particles 2 at a concentration of 20 mass % (polymer dispersion liquid 2) was obtained.

The 50% particle diameter (D50) of the polymer fine particles 2 on a volume distribution basis was measured with a dynamic light scattering-type particle size distribution meter NANOTRAC UPA-EX150 (manufactured by Nikkiso Co., Ltd.), and was found to be 0.40 μm.

(Preparation of Polymer Dispersion Liquid 3)

Under a nitrogen atmosphere, the following materials were loaded into a reaction vessel including a reflux condenser, a stirring machine, a temperature gauge, and a nitrogen-introducing tube.

| | | |
|---|---|---|
| Toluene | 100.00 | parts |
| Monomer composition | 100.00 | parts |
| Styrene | 75.00 | parts |
| Butyl acrylate | 25.00 | parts |
| t-Dodecylmercaptan | 1.0 | part |
| t-Butyl peroxypivalate | 5.0 | parts |

The above-mentioned respective components were mixed to prepare a monomer solution. A surfactant aqueous solution obtained by dissolving 10 parts of an anionic surfactant (manufactured by DKS Co., Ltd.: NEOGEN RK) in 1,130 parts of ion-exchanged water, and the monomer solution were loaded into a two-necked flask, and were stirred with a homogenizer (manufactured by IKA: ULTRA-TURRAX T50) at a number of revolutions of 10,000 r/min to be emulsified.

After that, the inside of the flask was purged with nitrogen, and the flask was heated in a water bath until the temperature of its contents became 70° C. while the contents were slowly stirred. Thus, polymerization was initiated.

After the reaction had been continued for 8 hours, the reaction liquid was cooled to room temperature, and its concentration was adjusted with ion-exchanged water. Thus, an aqueous dispersion liquid containing polymer fine particles 3 at a concentration of 20 mass % (polymer dispersion liquid 3) was obtained.

The 50% particle diameter (D50) of the polymer fine particles 3 on a volume distribution basis was measured with a dynamic light scattering-type particle size distribution meter NANOTRAC UPA-EX150 (manufactured by Nikkiso Co., Ltd.), and was found to be 0.40 μm.

Toner particles 31 was obtained in exactly the same manner as in the production example of the toner 30 except that 400 parts of polymer dispersion liquid 1 were changed to 208 parts of polymer dispersion liquid 2 and 192 parts of polymer dispersion liquid 3. In addition toner particles 32 was obtained in exactly the same manner as in the production example of the toner 30 except that 400 parts of polymer dispersion liquid 1 were changed to 192 parts of polymer dispersion liquid 2 and 208 parts of polymer dispersion liquid 3. In addition, toner particles 33 was obtained in exactly the same manner as in the production example of the toner 31 except that t-Dodecylmercaptan was not used as in the preparation of polymer dispersion liquid 3. In addition, toner particles 34 was obtained in exactly the same manner as in the production example of the toner 31 except that t-Dodecylmercaptan was not used as in the preparation of polymer dispersion liquid 2.

Further, the same external addition as that of the toner 1 was performed to provide toners 31 to 34. SP values concerning the present disclosure are shown in Table 3. The physical properties of the toners are shown in Table 4.

### Production Examples of Comparative Toners 1, 2, 5, and 6

Comparative toner particles 1, 2, 5, and 6 were each obtained in exactly the same manner as in the production example of the toner 1 except that the kinds and amounts of the materials to be used were changed as shown in Table 2.

Further, the same external addition as that of the toner 1 was performed to provide comparative toners 1, 2, 5, and 6. SP values concerning the present disclosure are shown in Table 3. The physical properties of the toners are shown in Table 4.

### Production Example of Comparative Toner 3

Comparative toner particles 3 were obtained in exactly the same manner as in the production example of the toner 31 except that t-Dodecylmercaptan was not used as in the preparation of polymer dispersion liquid 2 and the preparation of polymer dispersion liquid 3.

Further, the same external addition as that of the toner 1 was performed to provide a comparative toner 3. SP values concerning the present disclosure are shown in Table 3. The physical properties of the toner are shown in Table 4.

### Production Example of Comparative Toner 4

(Synthesis of Crystalline Polyester Resin 1)

281 Parts of dodecanedioic acid and 283 parts of 1,6-hexanediol were loaded into a reaction vessel including a stirring machine, a temperature gauge, a cooling tube, and a nitrogen gas-introducing tube. After the inside of the reaction vessel had been purged with a dry nitrogen gas, 0.1 part of Ti(OBu)₄ was added to the mixture, and the whole was subjected to a stirring reaction in a stream of the nitrogen gas at about 180° C. for 8 hours. Further, 0.2 part of Ti(OBu)₄ was added to the resultant, and the temperature was increased to about 220° C., followed by the performance of a stirring reaction for 6 hours. After that, a pressure in the reaction vessel was reduced to 1,333.2 Pa, and a reaction was performed under reduced pressure to provide a crystalline polyester resin 1. The crystalline polyester resin 1 had a number-average molecular weight (Mn) of 5,500, a weight-average molecular weight (Mw) of 18,000, and a melting point (Tc) of 67° C.

(Preparation of Crystalline Resin Fine Particle Dispersion Liquid (C1))

30 Parts of the crystalline polyester resin 1 was melted, and was transferred to an emulsification dispersing machine “CAVITRON CD1010” (manufactured by Eurotec Co., Ltd.) at a transfer rate of 100 parts per minute while being in a molten state. In addition, simultaneously with the transfer of the crystalline polyester resin 1 in a molten state, dilute ammonia water having a concentration of 0.37 mass %, which had been obtained by diluting 70 parts of reagent-grade ammonia water with ion-exchanged water in an aqueous solvent tank, was transferred to the emulsification dispersing machine “CAVITRON CD1010” (manufactured by Eurotec Co., Ltd.) at a transfer rate of 0.1 liter per minute while being heated to 100° C. with a heat exchanger. Then, the emulsification dispersing machine “CAVITRON CD1010” (manufactured by Eurotec Co., Ltd.) was operated under the conditions of a rotor rotational speed of 60 Hz and a pressure of 5 kg/cm² to prepare a crystalline resin fine particle dispersion liquid (C1) of the crystalline polyester resin 1 having a solid content amount of 30 parts. At this time, the median diameter of particles in the crystalline resin fine particle dispersion liquid (C1) on a volume basis was 200 nm.

(Preparation of Amorphous Resin Fine Particle Dispersion Liquid (X1))

(1) First-Stage Polymerization

8 Parts of sodium dodecyl sulfate and 3,000 parts of ion-exchanged water were loaded into a 5 L reaction vessel having mounted thereto a stirring device, a temperature sensor, a cooling tube, and a nitrogen-introducing device, and a temperature in the vessel was increased to 80° C. while the mixture was stirred in a stream of nitrogen at a stirring speed of 230 rpm. After the temperature increase, a solution obtained by dissolving 10 parts of potassium persulfate in 200 parts of ion-exchanged water was added to the mixture, and the temperature of the resultant liquid was set to 80° C. again, followed by dropwise addition of a monomer mixed liquid formed of the following composition over 1 hour. After that, polymerization was performed by heating and stirring the mixture at 80° C. for 2 hours. Thus, a resin fine particle dispersion liquid (x1) was prepared.

| | | |
|---|---|---|
| Styrene | 480 | parts |
| n-Butyl acrylate | 250 | parts |
| Methacrylic acid | 68 | parts |

(2) Second-Stage Polymerization

A solution obtained by dissolving 7 parts of sodium polyoxyethylene(2) dodecyl ether sulfate in 3,000 parts of ion-exchanged water was loaded into a 5 L reaction vessel having mounted thereto a stirring device, a temperature sensor, a cooling tube, and a nitrogen-introducing device, and was heated to 98° C. After that, 80 parts (in terms of solid content) of the resin fine particle dispersion liquid (x1) and a solution, which had been obtained by dissolving monomers and a release agent formed of the following composition at 90° C., were added to the solution, and the materials were mixed and dispersed with a mechanical dispersing machine “CLEARMIX” (manufactured by M Technique Co., Ltd.) having a circulation path for 1 hour to prepare a dispersion liquid containing emulsified particles (oil droplets).

| | | |
|---|---|---|
| Styrene (St) | 285 | parts |
| n-Butyl acrylate (BA) | 95 | parts |
| Methacrylic acid (MAA) | 20 | parts |
| n-Octyl 3-mercaptopropionate | 8 | parts |
| Release agent: behenyl behenate (melting point: 73° C.) | 190 | parts |

Next, an initiator solution obtained by dissolving 6 parts of potassium persulfate in 200 parts of ion-exchanged water was added to the dispersion liquid, and polymerization was performed by heating and stirring the system at 84° C. over 1 hour. Thus, a resin fine particle dispersion liquid (x2) was prepared.

(3) Third-Stage Polymerization

Further, 400 parts of ion-exchanged water was added to the resin fine particle dispersion liquid (x2), and the materials were mixed well. After that, a solution obtained by dissolving 11 parts of potassium persulfate in 400 parts of ion-exchanged water was added to the mixture, and a monomer mixed liquid formed of the following composition was added dropwise to the whole under a temperature condition of 82° C. over 1 hour. After the completion of the dropwise addition, polymerization was performed by heating and stirring the mixture over 2 hours, and then the resultant was cooled to 28° C. to prepare an amorphous resin fine particle dispersion liquid (X1) formed of a vinyl resin (styrene-acrylic resin 1).

| | | |
|---|---|---|
| Styrene (St) | 308 | parts |
| n-Butyl acrylate (BA) | 147 | parts |
| Behenyl acrylate | 143 | parts |
| Acrylic acid (AA) | 52 | parts |
| n-Octyl 3-mercaptopropionate | 8 | parts |

The physical properties of the resultant amorphous resin fine particle dispersion liquid (X1) were measured, and as a result, its amorphous resin fine particles had a median diameter on a volume basis of 220 nm, a glass transition temperature (Tg) of 46° C., and a weight-average molecular weight (Mw) of 32,000.

(Preparation of Colorant Fine Particle Dispersion Liquid [Bk])

90 Parts of sodium dodecyl sulfate was dissolved in 1,600 parts of ion-exchanged water under stirring, and 420 parts of carbon black “REGAL 330R” (manufactured by Cabot Corporation) was gradually added to the solution while the solution was stirred. Next, the mixture was subjected to dispersion treatment with a stirring device “CLEARMIX” (manufactured by M Technique Co., Ltd.) to prepare a colorant fine particle dispersion liquid [Bk] having dispersed therein colorant fine particles. The median diameter of the colorant fine particles in the colorant fine particle dispersion liquid [Bk] on a volume basis was measured with an electrophoretic light scattering photometer “ELS-800” (manufactured by Otsuka Electronics Co., Ltd.), and was found to be 120 nm.

(Preparation of Shell-Use Amorphous Resin Fine Particle Dispersion Liquid (S1))

Raw material monomers for an addition polymerization-type resin (styrene-acrylic resin: StAc) including a bireactive monomer and a radical polymerization initiator described below were loaded into a dropping funnel.

| | |
|---|---|
| Styrene | 80 parts |
| N-Butyl acrylate | 20 parts |
| Acrylic acid | 10 parts |
| Polymerization initiator (di-t-butyl peroxide) | 16 parts |

In addition, the following raw material monomers for a polycondensation-type resin (amorphous polyester resin) were loaded into a four-necked flask mounted with a nitrogen-introducing tube, a dewatering tube, a stirring unit, and a thermocouple, and were heated to 170° C. to be dissolved.

| | | |
|---|---|---|
| Bisphenol A propylene oxide 2 mol adduct | 285.7 | parts |
| Terephthalic acid | 66.9 | parts |
| Fumaric acid | 47.4 | parts |

Next, the raw material monomers for an addition polymerization-type resin were added dropwise to the resultant under stirring over 90 minutes, and the mixture was aged for 60 minutes. After that, an unreacted addition polymerization monomer was removed under reduced pressure (8 kPa).

After that, 0.4 part of Ti(OBu)₄ was loaded as an esterification catalyst into the flask, and a temperature in the flask was increased to 235° C. The mixture was subjected to a reaction under normal pressure (101.3 kPa) for 5 hours and under reduced pressure (8 kPa) for 1 hour.

Next, the resultant was cooled to 200° C., and was then subjected to a reaction under reduced pressure (20 kPa) until its temperature reached a desired softening point. Next, the solvent was removed from the resultant. Thus, a shell-use resin (s1) serving as an amorphous resin was obtained. The resultant shell-use resin (s1) had a glass transition temperature (Tg) of 60° C. and a weight-average molecular weight (Mw) of 30,000.

100 Parts of the resultant shell-use resin (s1) was dissolved in 400 parts of ethyl acetate (manufactured by Kanto Chemical Co., Inc.), and the solution was mixed with 638 parts of a sodium lauryl sulfate solution having a concentration of 0.26 mass %, which had been produced in advance. The mixture was subjected to ultrasonic dispersion with an ultrasonic homogenizer “US-150T” (manufactured by Nihonseiki Kaisha Ltd.) at a V-LEVEL of 300 μA for 30 minutes while being stirred. After that, under a state in which the mixture was warmed to 40° C., ethyl acetate was completely removed with a diaphragm vacuum pump “V-700” (manufactured by BUCHI Labortechnik AG) while the mixture was stirred under reduced pressure for 3 hours. Thus, a shell-use amorphous resin fine particle dispersion liquid (S1) having a solid content amount of 13.5 mass % was prepared. At this time, the median diameter of particles in the shell-use amorphous resin fine particle dispersion liquid (S1) on a volume basis was 160 nm.

(Preparation of Comparative Toner Particles 4)

288 Parts by mass (in terms of solid content) of the amorphous resin fine particle dispersion liquid (X1) and 2,000 parts of ion-exchanged water were loaded into a reaction vessel having mounted thereto a stirring device, a temperature sensor, and a cooling tube. After that, a 5 mol/L aqueous solution of sodium hydroxide was added to the mixture to adjust its pH to 10 (measurement temperature: 25° C.).

30 Parts by mass (in terms of solid content) of the colorant fine particle dispersion liquid [Bk] was loaded into the amorphous resin fine particle dispersion liquid (X1) after the above-mentioned pH adjustment. Next, an aqueous solution obtained by dissolving 30 parts of magnesium chloride as an aggregating agent in 60 parts of ion-exchanged water was added to the mixture under stirring at 30° C. over 10 minutes. The temperature of the mixed liquid was increased to 80° C., and 40 parts of the crystalline resin fine particle dispersion liquid (C1) of the crystalline polyester resin 1 was added to the mixed liquid over 10 minutes to advance the aggregation of the particles. The particle diameters of the associated particles were measured with a “Coulter Multisizer 3” (manufactured by Beckman Coulter, Inc.), and at the time point when the median diameter thereof on a volume basis became 6.0 μm, 37 parts (in terms of solid content) of the shell-use amorphous resin fine particle dispersion liquid (S1) was loaded into the mixture over 30 minutes. At the time point when the supernatant of the reaction liquid became transparent, an aqueous solution obtained by dissolving 190 parts of sodium chloride in 760 parts of ion-exchanged water was added to the reaction liquid to stop particle growth. Further, the fusion of the particles was advanced by heating and stirring the mixture under a state in which its temperature was 80° C. At the time point when the average circularity of the fused particles measured with a toner average circularity-measuring device “FPIA-2100” (manufactured by Sysmex Corporation) (the number of particles to be detected in a HPF was 4,000) became 0.945, the mixture was cooled at a cooling rate of 2.5° C./min to 30° C.

Next, the mixture was subjected to solid-liquid separation. A dehydrated toner cake was redispersed in ion-exchanged water, and the resultant was subjected to solid-liquid separation. The foregoing operation was repeated three times, and the resultant was washed, and was then dried at 40° C. for 24 hours. Thus, comparative toner particles 4 were obtained.

Further, the same external addition as that of the toner 1 was performed to provide a comparative toner 4. The physical properties of the toner are shown in Table 4.

TABLE 2-1

| | Crystalline resin having unit (a) | | | | | | | | | | | |
|---|---|---|---|---|---|---|---|---|---|---|---|---|
| | First unit | | Second unit | | Third unit | | Fourth unit | | MM unit | | Sulfide | |
| | | First | | Second | | Third | | Fourth | Kind | MM | Kind | Number |
| | Kind of | unit | Kind of | unit | Kind of | unit | Kind of | unit | of | unit | of | of added |
| | monomer | mass % | monomer | mass % | monomer | mass % | monomer | mass % | MM | mass % | sulfide | parts |
| Toner | BEA | 49.85 | MAN | 29.91 | St | 6.98 | EMA | 12.96 | AA-6 | 0.30 | TDM | 1 |
| particle 1 | | | | | | | | | | | | |
| Toner | BEA | 49.85 | MAN | 29.91 | St | 6.98 | EMA | 12.96 | AA-6 | 0.30 | TDM | 1 |
| particle 2 | | | | | | | | | | | | |
| Toner | BEA | 49.85 | MAN | 29.91 | St | 6.98 | EMA | 12.96 | AA-6 | 0.30 | TDM | 1 |
| particle 3 | | | | | | | | | | | | |
| Toner | BEA | 49.85 | MAN | 29.91 | St | 6.98 | EMA | 12.96 | AA-6 | 0.30 | TDM | 1 |
| particle 4 | | | | | | | | | | | | |
| Toner | BEA | 49.85 | MAN | 29.91 | St | 6.98 | EMA | 12.96 | AA-6 | 0.30 | TDM | 1 |
| particle 5 | | | | | | | | | | | | |
| Toner | BEA | 49.85 | MAN | 29.91 | St | 6.98 | EMA | 12.96 | AA-6 | 0.30 | TDM | 1 |
| particle 6 | | | | | | | | | | | | |
| Toner | BEA | 49.85 | MAN | 29.91 | St | 6.98 | EMA | 12.96 | AA-6 | 0.30 | TDM | 1 |
| particle 7 | | | | | | | | | | | | |
| Toner | BEA | 49.85 | MAN | 29.91 | St | 6.98 | EMA | 12.96 | AA-6 | 0.30 | TDM | 1 |
| particle 8 | | | | | | | | | | | | |
| Toner | BEA | 49.85 | MAN | 29.91 | St | 6.98 | EMA | 12.96 | AA-6 | 0.30 | TDM | 1.5 |
| particle 9 | | | | | | | | | | | | |
| Toner | BEA | 49.85 | MAN | 29.91 | St | 6.98 | EMA | 12.96 | AA-6 | 0.30 | TDM | 0.5 |
| particle 10 | | | | | | | | | | | | |
| Toner | BEA | 49.85 | MAN | 29.91 | St | 6.98 | EMA | 12.96 | AA-6 | 0.30 | MOP | 1 |
| particle 11 | | | | | | | | | | | | |
| Toner | BEA | 49.85 | MAN | 29.91 | St | 6.98 | EMA | 12.96 | AA-6 | 0.30 | TDM | 1 |
| particle 12 | | | | | | | | | | | | |
| Toner | BEA | 49.85 | MAN | 29.91 | St | 6.98 | EMA | 12.96 | AA-6 | 0.30 | TDM | 1 |
| particle 13 | | | | | | | | | | | | |
| Toner | BEA | 49.85 | MAN | 29.91 | St | 6.98 | EMA | 12.96 | AA-6 | 0.30 | TDM | 1 |
| particle 14 | | | | | | | | | | | | |
| Toner | BEA | 49.85 | MAN | 29.91 | St | 6.98 | EMA | 12.96 | AA-6 | 0.30 | TDM | 1 |
| particle 15 | | | | | | | | | | | | |
| Toner | BEA | 49.85 | MAN | 29.91 | St | 6.98 | EMA | 12.96 | AA-6 | 0.30 | TDM | 1 |
| particle 16 | | | | | | | | | | | | |
| Toner | BEA | 49.85 | MAN | 29.91 | St | 6.98 | EMA | 12.96 | AA-6 | 0.30 | TDM | 1 |
| particle 17 | | | | | | | | | | | | |
| Toner | BEA | 49.85 | MAN | 29.91 | St | 6.98 | EMA | 12.96 | AA-6 | 0.30 | TDM | 1 |
| particle 18 | | | | | | | | | | | | |
| Toner | BEA | 49.85 | MAN | 29.91 | St | 6.98 | EMA | 12.96 | AA-6 | 0.30 | TDM | 1 |
| particle 19 | | | | | | | | | | | | |
| Toner | BEA | 49.85 | MAN | 29.91 | St | 6.98 | EMA | 12.96 | AA-6 | 0.30 | TDM | 1 |
| particle 20 | | | | | | | | | | | | |
| Toner | BEA | 49.85 | AN | 29.91 | St | 6.98 | EMA | 12.96 | AA-6 | 0.30 | TDM | 1 |
| particle 21 | | | | | | | | | | | | |
| Toner | BEA | 49.85 | VA | 29.91 | St | 6.98 | EMA | 12.96 | AA-6 | 0.30 | TDM | 1 |
| particle 22 | | | | | | | | | | | | |
| Toner | BEA | 49.85 | MMA | 29.91 | St | 6.98 | EMA | 12.96 | AA-6 | 0.30 | TDM | 1 |
| particle 23 | | | | | | | | | | | | |
| Toner | BEA | 49.85 | MAN | 29.91 | St | 6.98 | EMA | 12.96 | AK-32 | 0.30 | TDM | 1 |
| particle 24 | | | | | | | | | | | | |
| Toner | BEA | 50.00 | MAN | 30.00 | St | 7.00 | EMA | 13.00 | — | — | TDM | 1 |
| particle 25 | | | | | | | | | | | | |
| Toner | BEA | 41.87 | MAN | 29.91 | St | 9.97 | EMA | 17.95 | AA-6 | 0.30 | TDM | 1 |
| particle 26 | | | | | | | | | | | | |
| Toner | BEA | 37.89 | MAN | 29.91 | St | 14.96 | EMA | 16.95 | AA-6 | 0.30 | TDM | 1 |
| particle 27 | | | | | | | | | | | | |
| Toner | BEA | 77.77 | MAN | 11.96 | St | 2.99 | EMA | 6.98 | AA-6 | 0.30 | TDM | 1 |
| particle 28 | | | | | | | | | | | | |
| Toner | BEA | 81.75 | MAN | 9.97 | St | 1.99 | EMA | 5.98 | AA-6 | 0.30 | TDM | 1 |
| particle 29 | | | | | | | | | | | | |
| Toner | BEA | 50.00 | MAN | 30.00 | St | 7.00 | EMA | 13.00 | — | — | TDM | 1 |
| particle 30 | | | | | | | | | | | | |
| Toner | BEA | 50.00 | MAN | 30.00 | St | 7.00 | EMA | 13.00 | — | — | TDM | 1 |
| particle 31 | | | | | | | | | | | | |
| Toner | BEA | 50.00 | MAN | 30.00 | St | 7.00 | EMA | 13.00 | — | — | TDM | 1 |
| particle 32 | | | | | | | | | | | | |
| Toner | BEA | 50.00 | MAN | 30.00 | St | 7.00 | EMA | 13.00 | — | — | TDM | 1 |
| particle 33 | | | | | | | | | | | | |
| Toner | BEA | 50.00 | MAN | 30.00 | St | 7.00 | EMA | 13.00 | — | — | — | — |
| particle 34 | | | | | | | | | | | | |
| Toner | STA | 49.85 | MAN | 29.91 | St | 6.98 | EMA | 12.96 | AA-6 | 0.30 | TDM | 1 |
| particle 35 | | | | | | | | | | | | |
| Toner | MIA | 49.85 | MAN | 29.91 | St | 6.98 | EMA | 12.96 | AA-6 | 0.30 | TDM | 1 |
| particle 36 | | | | | | | | | | | | |
| Comparative | BEA | 49.85 | MAN | 29.91 | St | 6.98 | EMA | 12.96 | AA-6 | 0.30 | — | — |
| toner particle 1 | | | | | | | | | | | | |
| Comparative | BEA | 49.85 | MAN | 29.91 | St | 6.98 | EMA | 12.96 | AA-6 | 0.30 | — | — |
| toner particle 2 | | | | | | | | | | | | |
| Comparative | BEA | 50.00 | MAN | 30.00 | St | 7.00 | EMA | 13.00 | — | — | — | — |
| toner particle 3 | | | | | | | | | | | | |
| Comparative | See specification | | | | | | | | | | | |
| toner particle 4 | | | | | | | | | | | | |
| Comparative | HDA | 49.85 | MAN | 29.91 | St | 6.98 | EMA | 12.96 | AA-6 | 0.30 | TDM | 1 |
| toner particle 5 | | | | | | | | | | | | |
| Comparative | BEA | 86.74 | MAN | 12.96 | — | — | — | — | AA-6 | 0.30 | TDM | 1 |
| toner particle 6 | | | | | | | | | | | | |

Crystalline resing

| | having unit (a) | | Resin except crystalline resin having unit (a) | | | | | | | |
|---|---|---|---|---|---|---|---|---|---|---|
| | Initiator | | First unit | | Second unit | | Sulfide | | Initiator | |
| | | Number | | First | | Second | | Number | | Number |
| | Kind of | of added | Kind of | unit | Kind of | unit | Kind of | of added | Kind of | of added |
| | initiator | parts | monomer | mass % | monomer | mass % | sulfide | parts | initiator | parts |
| Toner | PV | 5 | — | — | — | — | — | — | — | — |
| particle 1 | | | | | | | | | | |
| Toner | PV | 5 | — | — | — | — | — | — | — | — |
| particle 2 | | | | | | | | | | |
| Toner | PV | 5 | — | — | — | — | — | — | — | — |
| particle 3 | | | | | | | | | | |
| Toner | PV | 5 | — | — | — | — | — | — | — | — |
| particle 4 | | | | | | | | | | |
| Toner | PV | 5 | — | — | — | — | — | — | — | — |
| particle 5 | | | | | | | | | | |
| Toner | PV | 5 | — | — | — | — | — | — | — | — |
| particle 6 | | | | | | | | | | |
| Toner | PV | 5 | — | — | — | — | — | — | — | — |
| particle 7 | | | | | | | | | | |
| Toner | PV | 5 | — | — | — | — | — | — | — | — |
| particle 8 | | | | | | | | | | |
| Toner | PV | 5 | — | — | — | — | — | — | — | — |
| particle 9 | | | | | | | | | | |
| Toner | PV | 5 | — | — | — | — | — | — | — | — |
| particle 10 | | | | | | | | | | |
| Toner | PV | 5 | — | — | — | — | — | — | — | — |
| particle 11 | | | | | | | | | | |
| Toner | PV | 5 | — | — | — | — | — | — | — | — |
| particle 12 | | | | | | | | | | |
| Toner | PV | 5 | — | — | — | — | — | — | — | — |
| particle 13 | | | | | | | | | | |
| Toner | PV | 5 | — | — | — | — | — | — | — | — |
| particle 14 | | | | | | | | | | |
| Toner | PV | 5 | — | — | — | — | — | — | — | — |
| particle 15 | | | | | | | | | | |
| Toner | PV | 5 | — | — | — | — | — | — | — | — |
| particle 16 | | | | | | | | | | |
| Toner | PV | 5 | — | — | — | — | — | — | — | — |
| particle 17 | | | | | | | | | | |
| Toner | PV | 5 | — | — | — | — | — | — | — | — |
| particle 18 | | | | | | | | | | |
| Toner | PV | 5 | — | — | — | — | — | — | — | — |
| particle 19 | | | | | | | | | | |
| Toner | PV | 5 | — | — | — | — | — | — | — | — |
| particle 20 | | | | | | | | | | |
| Toner | PV | 5 | — | — | — | — | — | — | — | — |
| particle 21 | | | | | | | | | | |
| Toner | PV | 5 | — | — | — | — | — | — | — | — |
| particle 22 | | | | | | | | | | |
| Toner | PV | 5 | — | — | — | — | — | — | — | — |
| particle 23 | | | | | | | | | | |
| Toner | PV | 5 | — | — | — | — | — | — | — | — |
| particle 24 | | | | | | | | | | |
| Toner | PV | 5 | — | — | — | — | — | — | — | — |
| particle 25 | | | | | | | | | | |
| Toner | PV | 5 | — | — | — | — | — | — | — | — |
| particle 26 | | | | | | | | | | |
| Toner | PV | 5 | — | — | — | — | — | — | — | — |
| particle 27 | | | | | | | | | | |
| Toner | PV | 5 | — | — | — | — | — | — | — | — |
| particle 28 | | | | | | | | | | |
| Toner | PV | 5 | — | — | — | — | — | — | — | — |
| particle 29 | | | | | | | | | | |
| Toner | PV | 5 | — | — | — | — | — | — | — | — |
| particle 30 | | | | | | | | | | |
| Toner | PV | 5 | St | 75 | BA | 25 | TDM | 1 | PV | 5 |
| particle 31 | | | | | | | | | | |
| Toner | PV | 5 | St | 75 | BA | 25 | TDM | 1 | PV | 5 |
| particle 32 | | | | | | | | | | |
| Toner | PV | 5 | St | 75 | BA | 25 | — | | PV | 5 |
| particle 33 | | | | | | | | | | |
| Toner | PV | 5 | St | 75 | BA | 25 | TDM | 1 | PV | 5 |
| particle 34 | | | | | | | | | | |
| Toner | PV | 5 | — | — | — | — | — | — | — | — |
| particle 35 | | | | | | | | | | |
| Toner | PV | 5 | — | — | — | — | — | — | — | — |
| particle 36 | | | | | | | | | | |
| Comparative | PV | 5 | — | — | — | — | — | — | — | — |
| toner particle 1 | | | | | | | | | | |
| Comparative | PV | 5 | — | — | — | — | — | — | — | — |
| toner particle 2 | | | | | | | | | | |
| Comparative | PV | 5 | St | 75 | BA | 25 | — | — | PV | 5 |
| toner particle 3 | | | | | | | | | | |
| Comparative | See specification | | | | | | | | | |
| toner particle 4 | | | | | | | | | | |
| Comparative | PV | 5 | — | — | — | — | — | — | — | — |
| toner particle 5 | | | | | | | | | | |
| Comparative | PV | 5 | — | — | — | — | — | — | — | — |
| toner particle 6 | | | | | | | | | | |

TABLE 2-2

| | Numbers of added | | | | | | |
|---|---|---|---|---|---|---|---|
| | parts of crystalline | | | | | | |
| | resin and amorphous | | | | | | |
| | resin | | Shell-use resin | | Colorant | | |
| | Crystalline | Amorphous | Kind of shell- | Number of | Kind of | Number of | Production |
| | resin | resin | use resin | added parts | colorant | added parts | method |
| Toner particle 1 | 100 | 0 | Resin S1 | 4 | Carbon black | 8 | Suspension |
| | | | | | | | polymerization |
| Toner particle 2 | 100 | 0 | Resin S1 | 4 | PR122 | 6 | Suspension |
| | | | | | | | polymerization |
| Toner particle 3 | 100 | 0 | Resin S1 | 4 | PM31 | 6 | Suspension |
| | | | | | | | polymerization |
| Toner particle 4 | 100 | 0 | Resin S1 | 4 | PM150 | 6 | Suspension |
| | | | | | | | polymerization |
| Toner particle 5 | 100 | 0 | Resin S1 | 4 | PY74 | 6 | Suspension |
| | | | | | | | polymerization |
| Toner particle 6 | 100 | 0 | Resin S1 | 4 | PY155 | 6 | Suspension |
| | | | | | | | polymerization |
| Toner particle 7 | 100 | 0 | Resin S1 | 4 | PB15 | 6.5 | Suspension |
| | | | | | | | polymerization |
| Toner particle 8 | 100 | 0 | Resin S1 | 4 | PB15:3 | 6.5 | Suspension |
| | | | | | | | polymerization |
| Toner particle 9 | 100 | 0 | Resin S1 | 4 | PY74 | 6 | Suspension |
| | | | | | | | polymerization |
| Toner particle 10 | 100 | 0 | Resin S1 | 4 | PY74 | 6 | Suspension |
| | | | | | | | polymerization |
| Toner particle 11 | 100 | 0 | Resin S1 | 4 | PY74 | 6 | Suspension |
| | | | | | | | polymerization |
| Toner particle 12 | 100 | 0 | Resin S2 | 4 | PY74 | 6 | Suspension |
| | | | | | | | polymerization |
| Toner particle 13 | 100 | 0 | Resin S3 | 4 | PY74 | 6 | Suspension |
| | | | | | | | polymerization |
| Toner particle 14 | 100 | 0 | Resin S4 | 4 | PY74 | 6 | Suspension |
| | | | | | | | polymerization |
| Toner particle 15 | 100 | 0 | Resin S5 | 4 | PY74 | 6 | Suspension |
| | | | | | | | polymerization |
| 'Toner particle 16 | 100 | 0 | Resin S6 | 4 | PY74 | 6 | Suspension |
| | | | | | | | polymerization |
| Toner particle 17 | 100 | 0 | Resin S7 | 4 | PY74 | 6 | Suspension |
| | | | | | | | polymerization |
| Toner particle 18 | 100 | 0 | Resin 58 | 4 | PY74 | 6 | Suspension |
| | | | | | | | polymerization |
| Toner particle 19 | 100 | 0 | Resin S9 | 4 | PY74 | 6 | Suspension |
| | | | | | | | polymerization |
| Toner particle 20 | 100 | 0 | Resin S10 | 4 | PY74 | 6 | Suspension |
| | | | | | | | polymerization |
| Toner particle 21 | 100 | 0 | Resin S1 | 4 | PY74 | 6 | Suspension |
| | | | | | | | polymerization |
| Toner particle 22 | 100 | 0 | Resin S1 | 4 | PY74 | 6 | Suspension |
| | | | | | | | polymerization |
| Toner particle 23 | 100 | 0 | Resin S1 | 4 | PY74 | 6 | Suspension |
| | | | | | | | polymerization |
| Toner particle 24 | 100 | 0 | Resin S1 | 4 | PY74 | 6 | Suspension |
| | | | | | | | polymerization |
| Toner particle 25 | 100 | 0 | Resin S1 | 4 | PY74 | 6 | Suspension |
| | | | | | | | polymerization |
| Toner particle 26 | 100 | 0 | Resin S1 | 4 | PY74 | 6 | Suspension |
| | | | | | | | polymerization |
| Toner particle 27 | 100 | 0 | Resin S1 | 4 | PY74 | 6 | Suspension |
| | | | | | | | polymerization |
| Toner particle 28 | 100 | 0 | Resin S1 | 4 | PY74 | 6 | Suspension |
| | | | | | | | polymerization |
| Toner particle 29 | 100 | 0 | Resin S1 | 4 | PY74 | 6 | Suspension |
| | | | | | | | polymerization |
| Toner particle 30 | 100 | 0 | Resin S1 | 4 | PY74 | 6 | Emulsion |
| | | | | | | | aggregation |
| Toner particle 31 | 52 | 48 | Resin S1 | 4 | PY74 | 6 | Emulsion |
| | | | | | | | aggregation |
| Toner particle 32 | 48 | 52 | Resin S1 | 4 | PY74 | 6 | Emulsion |
| | | | | | | | aggregation |
| Toner particle 33 | 52 | 48 | Resin S1 | 4 | PY74 | 6 | Emulsion |
| | | | | | | | aggregation |
| Toner particle 34 | 52 | 48 | Resin S1 | 4 | PY74 | 6 | Emulsion |
| | | | | | | | aggregation |
| Toner particle 35 | 100 | 0 | Resin S1 | 4 | PY74 | 6 | Suspension |
| | | | | | | | polymerization |
| Toner particle 36 | 100 | 0 | Resin S1 | 4 | PY74 | 6 | Suspension |
| | | | | | | | polymerization |
| Comparative toner | 100 | 0 | Resin S1 | 4 | PY74 | 6 | Suspension |
| particle 1 | | | | | | | polymerization |
| Comparative toner | 100 | 0 | Resin S1 | 4 | PY74 | 6 | Suspension |
| particle 2 | | | Resin S11 | 1 | | | polymerization |
| Comparative toner | 52 | 48 | Resin S1 | 4 | PY74 | 6 | Emulsion |
| particle 3 | | | | | | | aggregation |
| Comparative toner | See specification | | | | | | |
| particle 4 | | | | | | | |
| Comparative toner | 100 | 0 | Resin S1 | 4 | PY74 | 6 | Suspension |
| particle 5 | | | | | | | polymerization |
| Comparative toner | 100 | 0 | Resin S1 | 4 | PY74 | 6 | Suspension |
| novtole 6 | | | | | | | polymerization |

BEA: behenyl acrylate

STA: stearyl acrylate

MIA: mynricyl acrylate

HAD: hexadecyl acrylate

MAN: methacrylonitrile

AN: acrylonitrile

VA: vinyl acetate

MMA: methyl methacrylate

St: styrene

EMA: ethyl methacrylate

AA-6: macromonomier AA-6 (Mn: 6,000) manufactured by Toagosei Co, Ltd.

Ak-32: macromonomer AK-32 (Mn: 20,000) manufactured by Toagosei Co.. Ltd.

TDM: t-dodecylmereaptan

MOP: octyl 3-merecaptopropionate

PV: t-butyl peroxypivalate (manufactured by NOF Corporation: PERBUTYLPV)

TABLE 3

| | SP value of | |
|---|---|---|
| | polymerizable monomer | SP value of unit |
| | (J/cm³)^{0.5} | (J/cm³)^{0.5} |
| Behenyl acrylate | 17.69 | 18.25 |
| Stearyl acrylate | 17.71 | 18.39 |
| Myricyl acrylate | 17.65 | 18.08 |
| Hexadecyl acrylate | 17.73 | 18.47 |
| Methacrylonitrile | 21.97 | 25.96 |
| Acrylonitrile | 22.75 | 29.43 |
| Vinyl acetate | 18.31 | 21.60 |
| Methyl methacrylate | 18.27 | 20.31 |
| Styrene | 17.94 | 20.11 |
| Ethyl methacrylate | 18.16 | 19.88 |

TABLE 4

| | | | | Endo- | | Content | | | | |
|---|---|---|---|---|---|---|---|---|---|---|
| | | | | thermic | | of (2) | | | | |
| | | | Maxi- | quantity | Content | crystalline | | | | |
| | | | mum | at | of (1) | resin | | | | |
| | | Weight- | endo- | maxi- | crystalline | having unit | | | | |
| | | average | thermic | mum | resin | (a) | Content | | | |
| | | particle | peak | endo- | having unit | and sulfide | of | | | |
| | | diameter | temp- | thermic | (a) with | structure with | unit (a) in | | | |
| | | (D4) | erature | peak | respect to | respect to | crystalline | | | |
| | | of toner | of toner | of toner | binder resin | binder resin | resin | | | SPb- |
| | | [μm] | [° C.] | [J/g] | [mass %] | [mass %] | [mass %] | SPa | SPb | SPa |
| Toner 1 | Toner particle 1 | 6.2 | 65 | 45 | — | 100 | 49.85 | 18.25 | 25.96 | 7.71 |
| Toner 2 | Toner particle 2 | 6.1 | 64 | 44 | — | 100 | 49.85 | 18.25 | 25.96 | 7.71 |
| Toner 3 | Toner particle 3 | 6.2 | 65 | 45 | — | 100 | 49.85 | 18.25 | 25.96 | 7.71 |
| Toner 4 | Toner particle 4 | 6.1 | 66 | 46 | — | 100 | 49.85 | 18.25 | 25.96 | 7.71 |
| Toner 5 | Toner particle 5 | 6.2 | 65 | 45 | — | 100 | 49.85 | 18.25 | 25.96 | 7.73 |
| Toner 6 | Toner particle 6 | 6.2 | 64 | 44 | — | 100 | 49.85 | 18.25 | 25.96 | 7 71 |
| Toner 7 | Toner particle 7 | 6.3 | 65 | 45 | — | 100 | 49.85 | 18 25 | 25.96 | 7.71 |
| Toner 8 | Toner particle 8 | 6.1 | 65 | 46 | — | 100 | 49.85 | 18.25 | 25.96 | 7.71 |
| Toner 9 | Toner particle 9 | 6.3 | 64 | 44 | — | 100 | 49.85 | 18.25 | 25.96 | 7.71 |
| Toner 10 | Toner particle 10 | 6.1 | 66 | 45 | — | 100 | 49.85 | 18.25 | 25.96 | 7.71 |
| Toner 11 | Toner particle 11 | 6.2 | 65 | 45 | — | 100 | 49.85 | 18.25 | 25.96 | 7.71 |
| Toner 12 | Toner particle 12 | 6.1 | 64 | 45 | — | 100 | 49.85 | 18.25 | 25.96 | 7.71 |
| Toner 13 | Toner particle 13 | 6.1 | 64 | 45 | — | 100 | 49.85 | 18.25 | 25.96 | 7 71 |
| Toner 14 | Toner particle 14 | 6.2 | 64 | 45 | — | 100 | 49.85 | 18 25 | 25.96 | 7.71 |
| Toner 15 | Toner particle 15 | 6.3 | 64 | 45 | — | 100 | 49.85 | 18.25 | 25.96 | 7.71 |
| Toner 16 | Toner particle 16 | 6.2 | 64 | 44 | — | 100 | 49.85 | 18.25 | 25.96 | 7.71 |
| Toner 17 | Toner particle 17 | 6.1 | 64 | 44 | — | 100 | 49.85 | 18.25 | 25.96 | 7.71 |
| Toner 18 | Toner particle 18 | 6.1 | 64 | 44 | — | 100 | 49.85 | 18.25 | 25.96 | 7.71 |
| Toner 19 | Toner particle 19 | 6.2 | 64 | 44 | — | 100 | 49.85 | 18.25 | 25.96 | 7.71 |
| Toner 20 | Toner particle 20 | 6.3 | 63 | 44 | — | 100 | 49.85 | 18.25 | 25.96 | 7.71 |
| Toner 21 | Toner particle 21 | 6.3 | 63 | 44 | — | 100 | 49.85 | 18 25 | 29.43 | 11.18 |
| Toner 22 | Toner particle 22 | 6.1 | 56 | 35 | — | 100 | 49.85 | 18.25 | 21.6 | 3.35 |
| Toner 23 | Toner particle 23 | 6.1 | 52 | 35 | — | 100 | 49.85 | 18.25 | 20.31 | 2.06 |
| Toner 24 | Toner particle 24 | 6.2 | 62 | 40 | — | 100 | 49.85 | 18.25 | 25.96 | 7 71 |
| Toner 25 | Toner particle 25 | 6.1 | 60 | 37 | — | 100 | 50.00 | 18 25 | 25.96 | 7.71 |
| Toner 26 | Toner particle 26 | 6.1 | 59 | 27 | — | 100 | 41.87 | 18.25 | 25.96 | 7.71 |
| Toner 27 | Toner particle 27 | 6.2 | 58 | 31 | — | 100 | 37.89 | 18.25 | 25.96 | 7.71 |
| Toner 28 | Toner particle 28 | 6.2 | 64 | 64 | — | 100 | 77.77 | 18.25 | 25.96 | 7.71 |
| Toner 29 | Toner particle 29 | 6.1 | 64 | 69 | — | 100 | 81.75 | 18.25 | 25.96 | 7.71 |
| Toner 30 | Toner particle 30 | 6.2 | 64 | 44 | — | 100 | 49.85 | 18.25 | 25.96 | 7.71 |
| Toner 31 | Toner particle 31 | 6.1 | 63 | 32 | — | 52 | 50.00 | 18.25 | 25.96 | 7.71 |
| Toner 32 | Toner particle 32 | 6.2 | 63 | 30 | — | 48 | 50.00 | 18 25 | 25.96 | 7.71 |
| Toner 33 | Toner particle 33 | 6.1 | 63 | 32 | — | 52 | 50.00 | 18.25 | 25.96 | 7.71 |
| Toner 34 | Toner particle 34 | 6.1 | 63 | 32 | 52 | — | 50.00 | 18.25 | 25.96 | 7.71 |
| Toner 35 | Toner particle 35 | 6.2 | 51 | 45 | — | 100 | 49.85 | 18.39 | 25.96 | 7.57 |
| Toner 36 | Toner particle 36 | 6.2 | 68 | 45 | — | 100 | 49.85 | 18.08 | 25.96 | 7.88 |
| Comparative | Comparative | 6.1 | 65 | 45 | — | 100 | 49.85 | 18 25 | 25.96 | 7.71 |
| toner 1 | toner particle 1 | | | | | | | | | |
| Comparative | Comparative | 6.2 | 65 | 45 | — | 100 | 49.85 | 18.25 | 25.96 | 7 71 |
| toner 2 | toner particle 2 | | | | | | | | | |
| Comparative | Comparative | 6.1 | 64 | 44 | — | 52 | 50.00 | 18.25 | 25.96 | 7.71 |
| toner 3 | toner particle 3 | | | | | | | | | |
| Comparative | Comparative | 6.1 | 67 | 8 | — | — | — | — | — | — |
| toner 4 | toner particle 4 | | | | | | | | | |
| Comparative | Comparative | 6.2 | 48 | 44 | — | 100 | 49.85 | 18.47 | 25.96 | 7.49 |
| toner 5 | toner particle 5 | | | | | | | | | |
| Comparative | Comparative | 6.3 | 64 | 75 | — | 100 | 86.74 | 18.25 | 25.96 | 7.71 |
| toner 6 | toner particle 6 | | | | | | | | | |

### Examples 1 to 36 and Comparative Examples 1 to 6

Each of the above-mentioned toners 1 to 36 and comparative toners 1 to 6 was subjected to evaluation tests. The evaluation methods and evaluation criteria of the present disclosure are described below.

<Evaluation of Low-Temperature Fixability of Toner>

A reconstructed machine of a laser beam printer (product name: LBP-7700C, manufactured by Canon Inc.) was used as an image-forming apparatus in the evaluation of the low-temperature fixability of each of the toners. The reconstructed points of the reconstructed machine were as follows: the machine was made capable of operating even when its fixing unit was removed; and its fixation temperature was made freely settable. In addition, paper used at the time of the output of an image was white paper (product name: Fox River Bond (90 g/m²), Fox River Fiber, LLC).

First, a toner was removed from the inside of the cartridge of the above-mentioned printer, and the inside was cleaned by air blowing. After that, 300 g of each of the toners was loaded into the cartridge. Then, the cartridge was left to stand under an environment having a temperature of 25° C. and a humidity of 40% RH for 48 hours, and was mounted on the cyan station of the printer under the environment. A dummy cartridge was mounted on any other station thereof. Hereinafter, an evaluation was performed under the same environment as that described above.

Subsequently, an unfixed image of an image pattern in which quadrangular images each measuring 10 mm by 10 mm were transferred onto 9 points serving as the points of intersection of lines dividing each of the long side and short side of the paper into 4 equal sections was output with the above-mentioned image-forming apparatus from which the fixing unit had been removed. A toner laid-on level on the paper was set to 0.80 mg/cm².

The above-mentioned unfixed image was fixed with the removed fixing unit as follows: the process speed of the fixing unit was set to 250 mm/s, and the initial temperature thereof was set to 90° C.; and while the preset temperature thereof was sequentially increased in increments of 5° C., the fixation was performed at the respective temperatures to provide fixed images at the respective temperatures. Each of the resultant fixed images was reciprocally rubbed with lens-cleaning paper “dusper (trademark)” (Ozu Paper Co., Ltd.) five times under a load of 50 g/cm². The densities of the image before and after the rubbing were measured, and the temperature at which the percentage by which the image density after the rubbing reduced as compared to the image density before the rubbing became 20% or less was defined as a fixation starting temperature, followed by the evaluation of the low-temperature fixability of the toner through use of the value. The toner having a fixation starting temperature of 120° C. or less was judged to provide the effect of the present disclosure. The results of the evaluation are shown in Table 5.

A: The fixation starting temperature is 100° C. or less.
B: The fixation starting temperature is 105° C. or more and 110° C. or less.
C: The fixation starting temperature is 115° C. or more and 120° C. or less.
D: The fixation starting temperature is 125° C. or more.

<Evaluation of Heat-Resistant Storage Stability of Toner>

6 g of each of the toners was loaded into a 100 mL polyvinyl cup, and was left to stand under an environment having a temperature of 50° C. and a humidity of 20% RH for 10 days. After that, the aggregation degree of the left toner 1 was measured as described below.

A product obtained by connecting a digital display-type vibration meter “DIGI-VIBRO MODEL 1332A” (manufactured by Showasokki Co., Ltd.) to the side surface portion of the vibrating table of a “POWDER TESTER” (manufactured by Hosokawa Micron Corporation) was used as a measuring apparatus. Then, a sieve having an aperture of 38 μm (400 meshes), a sieve having an aperture of 75 μm (200 meshes), and a sieve having an aperture of 150 μm (100 meshes) were set in the stated order from below on the vibrating table of the POWDER TESTER in an overlapping manner. The measurement was performed under an environment at 23° C. and 60% RH by the following procedure.

(1) The vibration amplitude of the vibrating table was adjusted in advance so that the value of the displacement of the digital display-type vibration meter became 0.60 mm (peak-to-peak).

(2) The toner left to stand for 10 days as described above was left to stand under the environment at 23° C. and 60% RH for 24 hours in advance. 5 g of the toner out of the toner was precisely weighed, and was gently mounted on the sieve having an aperture of 150 μm on the uppermost stage.

(3) After the sieves had been vibrated for 15 seconds, the masses of the toner remaining on the respective sieves were measured, and the aggregation degree (%) was calculated by using the following equation. A rank C or more was judged to be satisfactory. The results of the evaluation are shown in Table 5.

Aggregation degree (%)={(mass (g) of sample on sieve having aperture of 150 μm)/5 (g)})×100+{(mass (g) of sample on sieve having aperture of 75 μm)/5 (g)}×100×0.6+{(mass (g) of sample on sieve having aperture of 38 μm)/5 (g)}×100×0.2

A: The aggregation degree is 19% or less.
B: The aggregation degree is 20% or more and 24% or less.
C: The aggregation degree is 25% or more and 29% or less.
D: The aggregation degree is 30% or more.

<Evaluation of Coloring Power>

Each of the toners was left to stand under a normal-temperature and normal-humidity environment (having a temperature of 23° C. and a relative humidity of 50%) for 24 hours together with the toner cartridge of a laser beam printer LBP9600C.

The toner cartridge after the 24 hours of standing was mounted to the LBP9600C, and such a solid image that a toner laid-on level on the evaluation paper was 0.45 mg/cm² was output. The density of the image was measured with a color reflection densitometer (X-RITE 404A: manufactured by X-Rite, Inc.), and was evaluated.

Further, an image having a print percentage of 1.0% was printed out on up to 3,000 sheets of A4 paper in a lateral direction. After the output on the 3,000 sheets, the solid image was similarly output, and the density of the image was measured with the color reflection densitometer, and was evaluated.

A rank C or more was judged to be satisfactory. The results of the evaluation are shown in Table 5.

(Evaluation Criteria)

A: The image density is 1.40 or more.
B: The image density is 1.35 or more and 1.39 or less.
C: The image density is 1.20 or more and 1.34 or less.
D: The image density is 1.19 or less.

<Evaluation of Fogging Suppression>

The following test was performed: a horizontal line image having a print percentage of 1% was printed out on 3,000 sheets under a low-temperature and low-humidity environment (15° C., 10% RH) with each of the toners. After the completion of the test, the toner was left to stand for 48 hours, and then the image was further printed out. The reflectance (%) of the non-image portion of the image was measured with a “REFLECTOMETER MODEL TC-6DS” (manufactured by Tokyo Denshoku Co., Ltd.).

An evaluation was performed by using a numerical value (%), which was obtained by subtracting the resultant reflectance from the reflectance (%) of unused print-out paper (standard paper) similarly measured, by the following criteria. A smaller numerical value means that image fogging is suppressed to a larger extent. The evaluation was performed in a gloss paper mode by using plain paper (HP Brochure Paper 200 g, Glossy, manufactured by Hewlett-Packard Company, 200 g/m²). A rank C or more was judged to be satisfactory.

(Evaluation Criteria)

A: 1.0% or less
B: 1.1% or more and 3.0% or less
C: 3.1% or more and 5.0% or less
D: 5.1% or more

TABLE 15

| | | | Heat- | Image density (normal | | Fogging (low temperature | |
|---|---|---|---|---|---|---|---|
| | | Low- | resistant | temperature and normal humidity) | | and low humidity) | |
| | | temperature | Storage | | After output on | | After output on |
| | | fixability | stability | Initial stage | 3,000 sheets | Initial stage | 3,000 sheets |
| Example 1 | Toner 1 | A | A | A | A | A | A |
| | | 95 | 15 | 1.52 | 1.50 | 0.3 | 0.5 |
| Example 2 | Toner 2 | A | A | A | A | A | A |
| | | 95 | 14 | 1.51 | 1.49 | 0.3 | 0.5 |
| Example 3 | Toner 3 | A | A | A | A | A | A |
| | | 95 | 15 | 1.50 | 1.49 | 0.3 | 0.5 |
| Example 4 | Toner 4 | A | A | A | A | A | A |
| | | 95 | 16 | 1.52 | 1.50 | 0.3 | 0.5 |
| Example 5 | Toner 5 | A | A | A | A | A | A |
| | | 95 | 15 | 1.52 | 1.50 | 0.3 | 0.5 |
| Example 6 | Toner 6 | A | A | A | A | A | A |
| | | 95 | 15 | 1.51 | 1.49 | 0.3 | 0.5 |
| Example 7 | Toner 7 | A | A | A | A | A | A |
| | | 95 | 16 | 1.52 | 1.51 | 0.3 | 0.5 |
| Example 8 | Toner 8 | A | A | A | A | A | A |
| | | 95 | 15 | 1.52 | 1 50 | 0.3 | 0.5 |
| Example 9 | Toner 9 | A | A | A | A | A | A |
| | | 95 | 19 | 1.54 | 1.49 | 0.3 | 0.7 |
| Example 10 | Toner 10 | A | A | A | A | A | A |
| | | 100 | 14 | 1.49 | 148 | 0.3 | 0.4 |
| Example 11 | Toner 11 | A | A | A | A | A | A |
| | | 95 | 15 | 1.52 | 1.50 | 0.3 | 0.5 |
| Example 12 | Toner 12 | A | A | A | A | A | B |
| | | 95 | 17 | 1.49 | 1.42 | 0.6 | 2.0 |
| Example 13 | Toner 13 | A | B | A | B | A | B |
| | | 95 | 20 | 1.46 | 1.39 | 0.8 | 2.5 |
| Example 14 | Toner 14 | A | B | A | A | B | B |
| | | 95 | 20 | 1.49 | 1.41 | 1.1 | 2.5 |
| Example 15 | Toner 15 | A | B | A | B | B | B |
| | | 95 | 20 | 1.46 | 1.38 | 1.5 | 2.8 |
| Example 16 | Toner 16 | A | B | A | B | B | B |
| | | 95 | 22 | 1.42 | 1.37 | 1.6 | 2.9 |
| Example 17 | Toner 17 | A | B | B | B | B | C |
| | | 95 | 24 | 1.39 | 1.35 | 1.8 | 3.1 |
| Example 18 | Toner 18 | A | B | A | B | B | C |
| | | 100 | 20 | 1.42 | 1.37 | 1.5 | 3.2 |
| Example 19 | Toner 19 | B | B | A | B | B | C |
| | | 105 | 22 | 1.40 | 1.35 | 1.6 | 3.6 |
| Example 20 | Toner 20 | A | A | A | A | A | A |
| | | 95 | 19 | 1.49 | 1.42 | 0.3 | 0.5 |
| Example 21 | Toner 21 | A | A | A | A | B | B |
| | | 95 | 16 | 1.50 | 1.44 | 1.2 | 1.8 |
| Example 22 | Toner 22 | A | C | C | C | B | C |
| | | 100 | 25 | 1.32 | 1.28 | 1.5 | 3.4 |
| Example 23 | Toner 23 | B | C | C | C | C | C |
| | | 105 | 29 | 1.27 | 1.21 | 3.4 | 4.8 |
| Example 24 | Toner 24 | A | B | A | A | A | B |
| | | 100 | 20 | 1.52 | 1.40 | 0.5 | 1.2 |
| Example 25 | Toner 25 | A | B | A | B | A | B |
| | | 100 | 24 | 1.52 | 1.37 | 0.5 | 2.4 |
| Example 26 | Toner 26 | C | B | A | B | A | B |
| | | 115 | 22 | 1.50 | 1.39 | 0.8 | 2.6 |
| Example 27 | Toner 27 | C | B | A | B | A | B |
| | | 120 | 24 | 1.48 | 1.36 | 0.8 | 2.9 |
| Example 28 | Toner 28 | A | A | C | C | A | A |
| | | 95 | 16 | 1.34 | 1.25 | 0.5 | 0.9 |
| Example 29 | Toner 29 | A | A | C | C | A | B |
| | | 95 | 16 | 1.29 | 1.21 | 0.8 | 1.1 |
| Example 30 | Toner 30 | A | B | A | A | B | B |
| | | 95 | 20 | 1.45 | 1.40 | 1.1 | 2.7 |
| Example 31 | Toner 31 | C | B | A | A | A | B |
| | | 115 | 22 | 1.46 | 1.42 | 0.8 | 2.4 |
| Example 32 | Toner 32 | C | B | A | A | A | B |
| | | 120 | 21 | 1.46 | 1.42 | 0.8 | 2.2 |
| Example 33 | Toner 33 | C | B | B | B | A | B |
| | | 115 | 22 | 1.39 | 1.36 | 0.8 | 2.4 |
| Example 34 | Totter 34 | C | B | C | C | A | B |
| | | 115 | 22 | 1.24 | 1.20 | 0.8 | 2.4 |
| Example 35 | Toner 35 | A | C | A | C | B | B |
| | | 95 | 28 | 1.45 | 1.22 | 1.1 | 2.7 |
| Example 36 | Toner 36 | C | A | C | C | A | A |
| | | 120 | 15 | 1.24 | 1.20 | 0.5 | 0.8 |
| Comparative | Comparative | A | A | D | D | B | B |
| Example 1 | toner 1 | 95 | 15 | 1.19 | 1.17 | 1.1 | 1.5 |
| Comparative | Comparative | A | A | D | D | B | B |
| Example 2 | toner 2 | 95 | 15 | 1.19 | 1.17 | 1.1 | 1.5 |
| Comparative | Comparative | A | B | D | D | B | B |
| Example 3 | toner 3 | 95 | 20 | 1.19 | 1.17 | 1.1 | 2.7 |
| Comparative | Comparative | D | C | D | D | C | D |
| Example 4 | toner 4 | 135 | 28 | 1.18 | 1.10 | 4.5 | 5.5 |
| Comparative | Comparative | A | A | B | B | B | B |
| Example 5 | toner 5 | 95 | 50 | 1.42 | 1.35 | 2.2 | 3.0 |
| Comparative | Comparative | A | A | C | D | A | B |
| Example 6 | toner 6 | 95 | 16 | 1.20 | 1.16 | 0.8 | 2.5 |

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2021-150940, filed Sep. 16, 2021, Japanese Patent Application No. 2022-115658, filed Jul. 20, 2022, and Japanese Patent Application No. 2022-132888, filed Aug. 24, 2022, which are hereby incorporated by reference herein in their entirety.

What is claimed is:

1. A toner comprising toner particles each containing a binder resin and a colorant,
wherein the binder resin is a resin satisfying at least one of the following specification (A) or (B):
(A) the binder resin contains a crystalline resin having a unit (a) represented by the following formula (1) and a resin having a sulfide structure; and
(B) the binder resin contains a crystalline resin having the sulfide structure and having the unit (a) represented by the following formula (1): 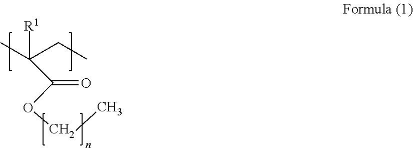
in the formula (1), R′ represents a hydrogen atom or a methyl group, and “n” represents an integer of 16 or more and 30 or less,
wherein the colorant is any colorant selected from the group consisting of: carbon black; titanium black; copper phthalocyanine; a copper phthalocyanine derivative; an anthraquinone compound; an azo pigment; and a fused polycyclic compound,
wherein when the toner is subjected to measurement with a differential scanning calorimeter, a peak temperature of a maximum endothermic peak is present in a range of from 50° C. or more to 70° C. or less, and
wherein the maximum endothermic peak has an endothermic quantity of 30 J/g or more and 70 J/g or less.

2. The toner according to claim 1, wherein the colorant is selected from the group consisting of: carbon black; C.I. Pigment Red 31; C.I. Pigment Red 122; C.I. Pigment Red 150; C.I. Pigment Yellow 74; C.I. Pigment Yellow 155; C.I. Pigment Blue 15; and C.I. Pigment Blue 15:3.

3. The toner according to claim 1, wherein the binder resin satisfies the specification (A), and a content of the crystalline resin having the unit (a) represented by the formula (1) in the binder resin is 50.0 mass % or more.

4. The toner according to claim 1, wherein the binder resin is a resin satisfying the specification (B).

5. The toner according to claim 4, wherein a content of the crystalline resin having the sulfide structure and having the unit (a) represented by the formula (1) in the binder resin is 50.0 mass % or more.

6. The toner according to claim 1, wherein a content of the unit (a) in the crystalline resin is 40.0 mass % or more and 80.0 mass % or less.

7. The toner according to claim 1,
wherein the binder resin contains a monomer unit derived from a macromonomer, and
wherein the monomer unit derived from the macromonomer has a number-average molecular weight of 1,000 or more and 20,000 or less.

8. The toner according to claim 7, wherein the monomer unit derived from the macromonomer has a (meth)acrylic acid ester polymer moiety.

9. The toner according to claim 1,
wherein the crystalline resin has a unit (b) in addition to the unit (a), and
wherein when an SP value ((J/cm³)^{0.5}) of the unit (a) is represented by SPa and an SP value ((J/cm³)^{0.5}) of the unit (b) is represented by SPb, the SPa and the SPb satisfy the following formula (2).
3.0≤(SPb−SPa)≤25.0 (2)

10. The toner according to claim 9, wherein the unit (b) is a unit represented by the following formula (3): 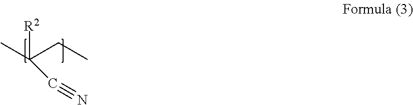
in the formula (3), R² represents a hydrogen atom or a methyl group.

11. The toner according to claim 1, wherein the toner particles each have a core-shell structure in which a core has the binder resin and a shell is an amorphous resin.

12. The toner according to claim 11, wherein the amorphous resin has 1.0 mass % or more and 30.0 mass % or less of a unit (c) represented by the formula (4): 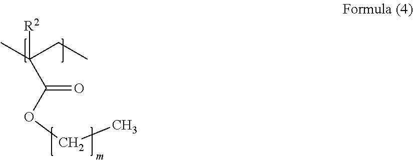
in the formula (4), R³ represents a hydrogen atom or a methyl group, and “m” represents an integer of from 10 to 24.

13. The toner according to claim 11, wherein the amorphous resin has an acid value Av of 5.0 mgKOH/g or more and 30.0 mgKOH/g or less.

14. The toner according to claim 1, wherein the toner particles are suspension polymerization method toner.
